(19) United States
(12) Patent Application Publication
(10) Pub. No.: US 2024/0193402 A1
(43) Pub. Date: Jun. 13, 2024

(54) METHOD AND APPARATUS FOR DETERMINING REPRESENTATION INFORMATION, DEVICE, AND STORAGE MEDIUM

(71) Applicant: Tencent Technology (Shenzhen) Company Limited, Shenzhen (CN)

(72) Inventors: Suying LIN, Shenzhen (CN); Lidong Zhang, Zhenzhen (CN); Siyuan Shi, Shenzhen (CN); Yucheng Lin, Shenzhen (CN); Mingyu Chi, Shenzhen (CN); Chunshui Wei, Shenzhen (CN); Yanhong Zhou, Shenzhen (CN); Chao Ruan, Shenzhen (CN)

(21) Appl. No.: 18/583,686

(22) Filed: Feb. 21, 2024

Related U.S. Application Data
(63) Continuation of application No. PCT/CN23/84684, filed on Mar. 29, 2023.

(30) Foreign Application Priority Data
Jun. 1, 2022 (CN) 202210613440.9

(51) Int. Cl. G06N 3/045; G06N 3/08

(52) U.S. Cl. CPC G06N 3/045; G06N 3/08

(57) ABSTRACT

Provided are a method for determining representation information performed by a computer device. The method includes: obtaining a heterogeneous graph of a target resource service; performing graph convolution on the heterogeneous graph through a graph neural network based on a plurality of types of meta-paths of a plurality of nodes in the heterogeneous graph, to obtain initial representation information of a first-class object node and initial representation information of a second-class object node; and fusing the initial representation information of the first-class object node and the initial representation information of the second-class object node based on an edge connecting different nodes in the heterogeneous graph, to obtain target representation information of the first-class object node.

### CROSS-REFERENCE TO RELATED APPLICATIONS

This application is a continuation application of PCT Patent Application No. PCT/CN2023/084684, entitled “METHOD AND APPARATUS FOR DETERMINING REPRESENTATION INFORMATION, DEVICE, AND STORAGE MEDIUM” filed on Mar. 29, 2023, which claims priority to Chinese Patent Application No. 202210613440.9, entitled “METHOD AND APPARATUS FOR DETERMINING REPRESENTATION INFORMATION, DEVICE, AND STORAGE MEDIUM” filed on Jun. 1, 2022, all of which is incorporated herein by reference in its entirety.

### FIELD OF THE TECHNOLOGY

This application relates to the field of computer technologies, and in particular, to a method and an apparatus for determining representation information, a device, and a storage medium.

### BACKGROUND OF THE DISCLOSURE

With the development of network technology, a quantity of media resources presented on the network is increasing. In view of this, how to recommend media resources that meet the needs of users from massive media resources has gradually become a mainstream direction of current research.

### SUMMARY

Embodiments of this application provide a method and an apparatus for determining representation information, a device, and a storage medium.

According to an aspect, a method for determining representation information is performed by a computer device. The method includes: obtaining a heterogeneous graph of a target resource service, the heterogeneous graph comprising a plurality of types of nodes, each type of nodes comprising at least one node representing one type of entities in the target resource service, an edge connecting different nodes being for representing an association relationship between entities, entities in the target resource service comprising a media resource, a first-class object, and a second-class object; performing graph convolution on the heterogeneous graph through a graph neural network based on a plurality of types of meta-paths of a plurality of nodes in the heterogeneous graph, to obtain initial representation information of a first-class object node corresponding to the first-class object and initial representation information of a second-class object node corresponding to the second-class object; and fusing the initial representation information of the first-class object node and the initial representation information of the second-class object node based on the connecting line between the plurality of nodes, to obtain target representation information of the first-class object node for recommending media resources to the first-class object.

According to an aspect, a computer device is provided. The computer device includes one or more processors and one or more memories. The one or more memories store at least one computer program. The at least one computer program is loaded and executed by the one or more processors to implement the method for determining representation information.

According to an aspect, a non-transitory computer-readable storage medium is provided. The computer-readable storage medium stores at least one computer program. The at least one computer program is loaded and executed by a processor of a computer device and causes the computer device to implement the method for determining representation information.

### BRIEF DESCRIPTION OF THE DRAWINGS

FIG. 1 is a schematic diagram of an implementation environment of a method for determining representation information according to an embodiment of this application.

FIG. 2 is a flowchart of a method for determining representation information according to an embodiment of this application.

FIG. 3 is a flowchart of another method for determining representation information according to an embodiment of this application.

FIG. 4 is a schematic diagram of connecting lines between nodes according to an embodiment of this application.

FIG. 5 is another schematic diagram of connecting lines between nodes according to an embodiment of this application.

FIG. 6 is a flowchart of heterogeneous graph construction according to an embodiment of this application.

FIG. 7 is a schematic diagram of a plurality of meta-paths of a first-class object node according to an embodiment of this application.

FIG. 8 is a schematic diagram of two types of meta-paths according to an embodiment of this application.

FIG. 9 is a flowchart of still another method for determining representation information according to an embodiment of this application.

FIG. 10 is a schematic diagram of positive and negative sample node pairs according to an embodiment of this application.

FIG. 11 is a schematic diagram of a structure of an apparatus for determining representation information according to an embodiment of this application.

FIG. 12 is a schematic diagram of a structure of a terminal according to an embodiment of this application.

FIG. 13 is a schematic diagram of a structure of a server according to an embodiment of this application.

### DESCRIPTION OF EMBODIMENTS

To make objectives, technical solutions, and advantages of this application clearer, the following further describes implementations of this application in detail with reference to the accompanying drawings. Apparently, the described embodiments are merely a part rather than all of the embodiments of this application.

The terms “first”, “second”, and the like in this application are used to distinguish identical or similar items having essentially the same action and function. It is to be understood that the terms “first”, “second”, and “nth” do not have logical or temporal dependence on each other, or limit a quantity or an order of execution.

Currently, service data of media resources is analyzed by using a graph neural network to determine which media resources to be recommended to a user. The essence of the graph neural network is a graph data processing method. Graph data for representing service data is processed to obtain representation information of nodes in the graph data, that is, to obtain a relationship between users and users or between users and media resources for recommendation. During media resource recommendation, it is inevitable that media resources need to be recommended to some users with less interactive data, which has corresponding requirements that cannot be met by the current graph neural network.

For ease of understanding of technical processes of the embodiments of this application, some terms involved in the embodiments of this application are described below:

A graph neural network (GNN) is a deep learning algorithm based on a graph structure. In computer science, a graph is a data structure formed by two parts: nodes and edges. The graph neural network is a neural network that acts directly on the graph structure, and is essentially a graph data processing method for obtaining graph data feature representation.

A heterogeneous graph is a graph that includes a plurality of node or edge types. The heterogeneous graph is different from a homogeneous graph. The homogeneous graph includes only one type of nodes and one type of edges, while the heterogeneous graph includes a plurality of types of nodes or a plurality of types of edges. For example, in a recommendation system, a to-be-recommended object and a to-be-recommended media resource are two different types of nodes.

A meta-path is a specific path pattern for connecting two types of entities in a graph structure. For example, the meta-path “video→user→video” connects two videos, so it is regarded as a way to explore a potential relationship between the videos.

Embedding, also referred to as characterization or representation, is vector representation of an entity in low-dimensional space, and is implicit representation expressed as a multidimensional vector. For example, a word, a product, a movie, and the like can be represented by embedding. This embedding representation is different from explicit entity features. For example, a title of a video is an explicit entity feature, while the embedding of the entity is an implicit feature.

An attention mechanism is essentially to locate information of interest and suppress useless information. The results are usually shown in the form of a probability graph or a probability feature vector, which is a mechanism commonly used in deep learning.

Item-based collaborative filtering (ICF) recall is to recommend other items to a user according to a historical behavior of selecting items of the user based on similarity between the items. For video recommendation, ICF recall is to recommend other videos to a user according to a historical behavior of selecting videos of the user based on similarity between the videos.

User-based collaborative filtering (UCF) recall is to find users with the same interest and recommend what one of the users has chosen to the other users. For video recommendation, UCF recall is to find a group with the same interest and recommend a video that has been selected by a user in the group to the other users in the group.

The information (including, but not limited to, user device information, user personal information, and the like), data (including, but not limited to, data for analysis, data stored, data presented, and the like), and signals involved in this application are all authorized by the user or fully authorized all parties, and the collection, use, and processing of relevant data need to comply with relevant laws, regulations, and standards of relevant countries and regions.

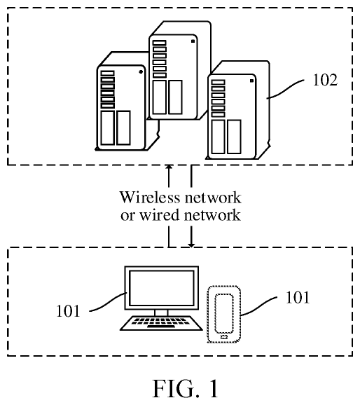

The following describes an implementation environment of this application. FIG. 1 is a schematic diagram of an implementation environment of a method for determining representation information according to an embodiment of this application. Referring to FIG. 1, the implementation environment includes: a terminal 101 and a server 102. The terminal 101 is connected to the server 102 by using a wired or wireless network.

Applications that support playing media resources are installed and run on the terminal 101. In some embodiments, the applications include a social application, a media resource application, and the like.

The terminal 101 is an on-board terminal, a smartphone, a tablet computer, a notebook computer, a desktop computer, a smart speaker, a smartwatch, a smart TV, or the like, which is not limited in the embodiments of this application.

The server 102 is an independent physical server, or a server cluster or distributed system including a plurality of physical servers, or a cloud server providing basic cloud computing services such as cloud services, cloud databases, cloud computing, cloud functions, cloud storage, network services, cloud communication, middleware services, domain name services, security services, content delivery networks (CDNs), and big data and artificial intelligence platforms. In some embodiments, there are more or less terminals or servers, which is not limited in the embodiments of this application.

In some embodiments, the terminal 101 and the server 102 can be used as nodes in a block chain system.

After the implementation environment of the embodiments of this application is described, the following describes an application scenario of the embodiments of this application with reference to the implementation environment. In the following description, a terminal is the terminal 101 in the implementation environment, and a server is the server 102 in the implementation environment.

The technical solutions provided in the embodiments of this application can be applied in a scenario of recommending various media resources, for example, applied in a scenario of recommending short videos, or applied in a scenario of recommending film and television works, or applied in a scenario of recommending music, or applied in a scenario of recommending articles. In other words, the media resources include, but are not limited to: video resources, audio resources, image-text resources, web-page resources, and the like.

In the scenario of recommending short videos, the terminal starts an application for viewing short videos. A first-class object logs in the application. The first-class object is a new user for recommendation services. The new user for recommendation services includes a newly registered user and a user who has viewed a small quantity of short videos (for example, a quantity of short videos that have been viewed is less than a set threshold). The terminal sends a short video recommendation request to the server. The short video recommendation request carries the first-class object. The server obtains the short video recommendation request and obtains the first-class object from the recommendation request. The server performs a query in an object database based on the first-class object to obtain target representation information of the first-class object. The target representation information can reflect, to a certain extent, preferences of the first-class object for short videos. The server performs matching in a short video database based on the target representation information to determine at least one candidate object. The candidate object is an object having the same or similar preferences for short videos as the first-class object. The server recommends, to the first-class object, short videos on which the at least one candidate object has had a target interaction behavior, to implement short video recommendation for the new user for recommendation services. In the foregoing process, the accuracy of the target representation information of the first-class object affects the accuracy of the short video recommendation. In the technical solutions provided in the embodiments of this application, initial representation information of a first-class object node and initial representation information of a second-class object node can be determined by using a heterogeneous graph. The first-class object node indicates the first-class object, that is, the new user for recommendation services. The second-class object node indicates a second-class object, that is, an old user for recommendation services. The initial representation information of the second-class object node and the initial representation information of the first-class object node are fused according to connecting lines (that is, connecting edges between nodes) in the heterogeneous graph. In other words, representation information of the new user for recommendation services is enriched by using initial representation information of the old user for recommendation services, to obtain target representation information of the first-class object node. The target representation information of the first-class object node can carry more information while increasing accuracy, so that the accuracy of short video recommendation based on the target representation information is high.

The foregoing process is described by using an example in which the server recommends short videos. Processes in scenarios in which the server recommends film and television works, music, and articles belong to the same inventive concept as the foregoing process, and details are not described herein again. Certainly, the technical solutions provided in the embodiments of this application may be applied in scenarios of recommending other types of media resources in addition to the foregoing scenarios, which is not limited in the embodiments of this application.

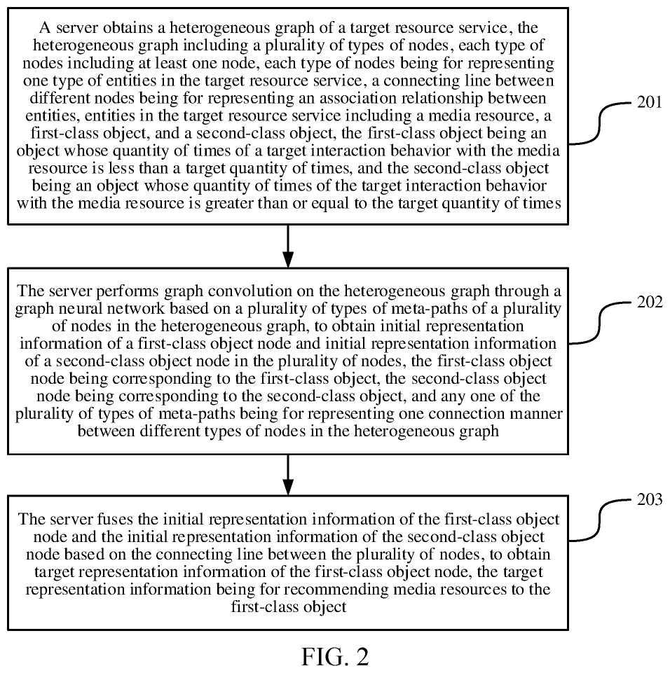

After the implementation environment and the application scenario of the embodiments of this application are described, the following describes the technical solutions provided in the embodiments of this application. Referring to FIG. 2, the technical solutions provided in the embodiments of this application are performed by a terminal or a server, or are jointly performed by a terminal and a server. Both the terminal and the server are examples of a computer device. In an embodiment of this application, the method is described by using an example in which an execution body is a server, including the following steps.

201. The server obtains a heterogeneous graph of a target resource service, the heterogeneous graph including a plurality of types of nodes, each type of nodes including at least one node, each type of nodes being for representing one type of entities in the target resource service, a connecting line between different nodes being for representing an association relationship between entities, entities in the target resource service including a media resource, a first-class object, and a second-class object, the first-class object being an object whose quantity of times of a target interaction behavior with the media resource is less than a target quantity of times, and the second-class object being an object whose quantity of times of the target interaction behavior with the media resource is greater than or equal to the target quantity of times.

The target resource service is a service of recommending media resources. The target resource service has corresponding meanings for different recommended media resources. For example, when a recommended media resource is videos, the target resource service is a video recommendation service; or when a recommended media resource is audio, the target resource service is an audio recommendation service.

The heterogeneous graph is a graph that includes two or more types of nodes. In the heterogeneous graph, when there is a connecting line between two nodes, these two nodes have an association relationship with each other. When there is no connecting line between two nodes, these two nodes do not have an association relationship with each other. The “connecting line” between different nodes in the heterogeneous graph involved in this embodiment of this application is an “edge” connecting different nodes in the heterogeneous graph. Since nodes included in the heterogeneous graph are of a plurality of types, two nodes connected by an “edge” may belong to the same type or may belong to different types. In some embodiments, the “edge” carries a weight or does not carry a weight.

The entity is a concept that has a meaning when the target resource service is performed. The determination of the entity is associated with the target resource service. The media resource of the target resource service may be a media resource provided for media resource recommendation, such as short videos, film and television works, music, or articles provided for recommendation. All the first-class object and the second-class object of the target resource service may be objects provided for media resource recommendation. The first-class object is an object whose quantity of times of the target interaction behavior with the media resource is less, that is, a new user for recommendation services. The target interaction behavior includes viewing, liking, sharing, favoriting, and commenting. The second-class object is an object whose quantity of times of the target interaction behavior with the media resource is greater, that is, an old user for recommendation services.

202. The server performs graph convolution on the heterogeneous graph through a graph neural network based on a plurality of types of meta-paths of a plurality of nodes in the heterogeneous graph, to obtain initial representation information of a first-class object node and initial representation information of a second-class object node in the plurality of nodes, the first-class object node being corresponding to the first-class object, the second-class object node being corresponding to the second-class object, and any one of the plurality of types of meta-paths being for representing one connection manner between different types of nodes in the heterogeneous graph.

The graph neural network is for performing graph convolution on the heterogeneous graph to obtain the initial representation information of the first-class object node and the initial representation information of the second-class object node. Each node in the heterogeneous graph indicates one entity of the target resource service. Since entity types include the media resource, the first-class object, and the second-class object, node types include a resource node, a first-class object node, and a second-class object node. The resource node indicates the media resource, the first-class object node indicates the first-class object, and the second-class object node indicates the second-class object.

In some embodiments, the graph neural network is obtained through training. The plurality of types of meta-paths represent different connection manners between different types of nodes in the heterogeneous graph. In this case, for a node in the heterogeneous graph, the first-class object node can belong to different meta-paths. In other words, because an edge in the heterogeneous graph can connect two nodes of the same type and can also connect two nodes of different types, one edge or a plurality of edges that are connected from head to tail can form a path, but not all paths meet a preset connection manner. A meta-path is a path filtered out of all paths according to the preset connection manner. For example, a plurality of meta-paths can be found from all paths in the heterogeneous graph by presetting a plurality of path patterns (that is, connection manners) of the meta-paths. These meta-paths are divided into a plurality of types of meta-paths according to different path patterns. Each type of meta-paths includes a plurality of meta-paths with the same path pattern. For example, if a path pattern is preset as “video→user→video”, all meta-paths that meet the path pattern “video→user→video” belong to the same type of meta-paths.

In step 202, the server performs graph convolution on the heterogeneous graph through the graph neural network based on the plurality of types of meta-paths of the plurality of nodes in the heterogeneous graph, to obtain the initial representation information of the first-class object node and the initial representation information of the second-class object node. Each type of meta-paths is meta-paths with a type of nodes as end points of the paths.

203. The server fuses the initial representation information of the first-class object node and the initial representation information of the second-class object node based on the connecting line between the plurality of nodes, to obtain target representation information of the first-class object node, the target representation information being for recommending media resources to the first-class object.

The connecting line between the plurality of nodes is for representing the association relationship between the plurality of nodes, that is, the edge connecting different nodes represents the association relationship between different entities. For example, when one first-class object node is connected to one resource node, a first-class object indicated by the first-class object node has had the target interaction behavior on a media resource indicated by the resource node. The resource node is a node that indicates the media resource in the heterogeneous graph.

In step 203, the server fuses the initial representation information of the first-class object node and the initial representation information of the second-class object node based on the edge connecting different nodes in the heterogeneous graph, to obtain the target representation information of the first-class object node, which is equivalent to adjusting the initial representation information of the first-class object node based on the initial representation information of the second-class object node, so that the target representation information of the first-class object node has a better expression capability, thereby increasing the accuracy of media resource recommendation.

The heterogeneous graph of the target resource service is obtained through the technical solution provided in this embodiment of this application. The heterogeneous graph includes nodes corresponding to a plurality of types of entities in the target resource service. The heterogeneous graph is processed through the graph neural network based on the plurality of types of meta-paths, to obtain the initial representation information of the first-class object node and the initial representation information of the second-class object node. Since the meta-paths connect different types of nodes, the initial representation information of the object nodes carries information about the media resources. The initial representation information of the first-class object node and the initial representation information of the second-class object node are fused based on the connecting line, to obtain the target representation information, which can more adequately represent the first-class object. The accuracy of recommending the media resource to the first-class object based on the target representation information is high.

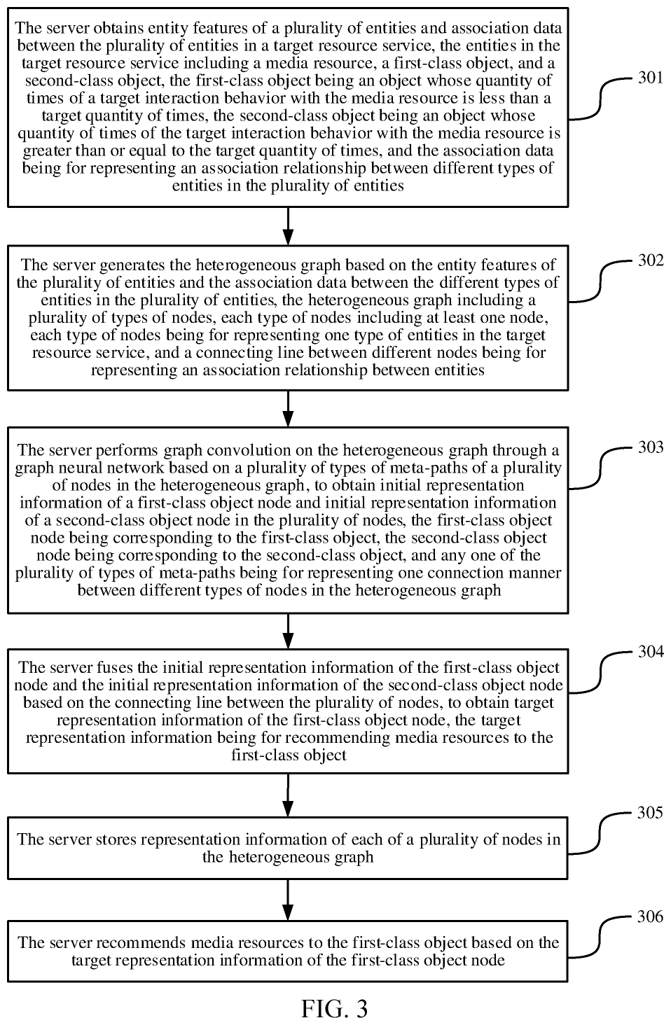

Steps 201 to 203 briefly describe the technical solutions provided in the embodiments of this application. The following more clearly describes the technical solutions provided in the embodiments of this application with reference to some examples. Referring to FIG. 3, the technical solutions provided in the embodiments of this application are performed by a terminal or a server, or are jointly performed by a terminal and a server. Both the terminal and the server are examples of a computer device. In an embodiment of this application, the method is described by using an example in which an execution body is a server, including the following steps.

301. The server obtains entity features of a plurality of entities and association data between the plurality of entities in a target resource service, the entities in the target resource service including a media resource, a first-class object, and a second-class object, the first-class object being an object whose quantity of times of a target interaction behavior with the media resource is less than a target quantity of times, the second-class object being an object whose quantity of times of the target interaction behavior with the media resource is greater than or equal to the target quantity of times, and the association data being for representing an association relationship between different types of entities in the plurality of entities.

In step 301, the server obtains an entity feature of each entity and association data between the different types of entities in the target resource service. Entity types include the media resource, the first-class object, and the second-class object. The association data is for representing the association relationship between the different types of entities. For example, the association data includes interactive data between the first-class object and the media resource and interactive data between the second-class object and the media resource.

There are a plurality of media resources, first-class objects, and second-class objects. The association data between the plurality of entities includes the interactive data between the first-class object and the media resource and the interactive data between the second-class object and the media resource. The first-class object is an object whose quantity of times of the target interaction behavior with the media resource is less than the target quantity of times, that is, an object whose quantity of times of the target interaction behavior with the media resource is less. The target quantity of times is set by a technician according to an actual situation, for example, set to 10, 15, or 20, which is not limited in the embodiments of this application. The target interaction behavior includes viewing, liking, sharing, favoriting, and commenting. When the first-class object is a first-class user account, the first-class object is also referred to as a new user account for recommendation services. The new user account for recommendation services includes a newly registered user account and a user account with low activity. The low activity means a less quantity of times of the target interaction behavior. The second-class object is an object whose quantity of times of the target interaction behavior with the media resource is greater than or equal to the target quantity of times, that is, an object whose quantity of times of the target interaction behavior with the media resource is greater. When the second-class object is a second-class user account, the second-class object is also referred to as an old user account for recommendation services or a user account with high activity. The high activity means a greater quantity of times of the target interaction behavior. In some embodiments, the first-class object is also referred to as a new user for recommendation services, and the second-class object is also referred to as an old user for recommendation services. The target interaction behavior is also referred to as a positive behavior.

The association data between the plurality of entities includes the interactive data between the first-class object and the media resource and the interactive data between the second-class object and the media resource. For the first-class object, the interactive data between the first-class object and the media resource includes relevant data of the target interaction behavior of the first-class object on the media resource, for example, relevant data of interaction behaviors, such as viewing, liking, sharing, favoriting, and commenting, of the first-class object on the media resource. In some embodiments, the relevant data includes time for performing the target interaction behavior. The interactive data between the first-class object and the media resource further includes dependent data between the first-class object and the media resource. For example, the first-class object is a producer of a media resource. For the second-class object, the interactive data between the second-class object and the media resource includes relevant data of the target interaction behavior of the second-class object on the media resource, for example, relevant data of interaction behaviors, such as viewing, liking, sharing, favoriting, and commenting, of the second-class object on the media resource. In some embodiments, the relevant data includes time for performing the target interaction behavior. The interactive data between the second-class object and the media resource further includes dependent data between the second-class object and the media resource. For example, the second-class object is a producer of a media resource.

In some embodiments, the association data between the plurality of entities further includes at least one of association data between the first-class object and the second-class object, association data between a plurality of second-class objects, and association data between a plurality of media resources, which is not limited in the embodiments of this application. The association data between the first-class object and the second-class object is for representing an association relationship between the first-class object and the second-class object. For example, the first-class object is invited by the second-class object. The association data between the plurality of second-class objects includes data such as follows and invitations between the plurality of second-class objects. The association data between the plurality of media resources includes source data between the plurality of media resources. For example, the source data records that two media resources are from the same producer or that two media resources are from the same media resource collection.

The entity features of the plurality of entities are also referred to as entity information of the plurality of entities. For example, an entity feature of a media resource includes an identifier, a tag, a producer, a type, and background music of the media resource. An entity feature of an object includes basic information such as an identifier, an age, a gender, and a geographical region of the object. The object includes the first-class object and the second-class object. The entity feature of the object can only be obtained with permission of the object. The server can obtain and use the entity feature of the object only with the permission of the object. For example, when the object is using a media resource application, the application displays an access permission pop-up window, and the access permission pop-up window shows the content of the entity feature that is desired to be obtained and used. The server can obtain and use the entity feature of the object only when the object clicks on/taps a confirm button.

In some embodiments, the entity features of the plurality of entities and the association data between the plurality of entities in the target resource service are collectively referred to as service data of the target resource service.

In a possible implementation, the server obtains initial service data of the target resource service. The initial service data includes resource features of a plurality of candidate media resources, a plurality of candidate first-class objects, a plurality of candidate second-class objects, and association data among the candidate media resources, the candidate first-class objects, and the candidate second-class objects. The server preprocesses the initial service data based on a target rule to obtain target resource service data of the target resource service. The target resource service data includes a resource feature of the media resource, an object feature of the first-class object, an object feature of the second-class object, and association data among the media resource, the first-class object, and the second-class object.

The plurality of candidate media resources are media resources recorded in a resource database maintained by the server correspondingly. The plurality of candidate first-class objects and the plurality of candidate second-class objects are objects stored in an object database maintained by the server correspondingly. The target rule is a rule for data preprocessing and is set by a technician according to an actual situation, which is not limited in the embodiments of this application. In some embodiments, the process of preprocessing the initial service data is also referred to as a process of performing data cleaning or data filtering on the initial service data.

In this implementation, the server can preprocess the initial service data based on the target rule. Some erroneous or abnormal data can be eliminated through the process of preprocessing, which can reduce the data volume and increase the accuracy of subsequent processing.

The following describes the method for the server to preprocess the initial service data based on the target rule to obtain the target resource service data of the target resource service in the foregoing implementation.

In some embodiments, the target rule includes whether a candidate media resource meets a first target condition, whether a candidate first-class object and a candidate second-class object meet a second target condition, and whether candidate association data between the plurality of candidate objects and the plurality of candidate media resources meets a third target condition. The server deletes candidate media resources and corresponding resource features that meet the first target condition from the plurality of candidate media resources, to obtain the media resource and the resource feature of the media resource. The server deletes candidate first-class objects, candidate second-class objects, and corresponding object features that meet the second target condition from the plurality of candidate first-class objects and the plurality of candidate second-class objects, to obtain the first-class object, the second-class object, and the corresponding object features. The server deletes candidate association data that meets the third target condition from the candidate association data, to obtain the association data.

In some embodiments, that the candidate media resources meet the first target condition means at least one of the following cases: Deleted candidate media resources, media resources deleted by producers of the media resources, no longer have reference value, and therefore need to be filtered out. Media resources that fail review also have no reference value, and therefore need to be filtered out. A quantity of times of playing a candidate media resource is less than or equal to a threshold of a quantity of times of playing. Since candidate media resources played less times have little reference value, the server can eliminate the candidate media resources played less times. In some embodiments, the candidate media resources played less times are also referred to as low-frequency played media resources. A quantity of times of interaction between a candidate media resource and an object is less than or equal to a threshold of a quantity of times of interaction. Since candidate media resources with a less quantity of times of interaction have little reference value, the server can eliminate the candidate media resources with a less quantity of times of interaction. In some embodiments, the candidate media resources with a less quantity of times of interaction are also referred to as low-frequency interaction media resources. Duration of a candidate media resource is less than or equal to a threshold of resource duration. Since candidate media resources with shorter duration have little reference value, the server can eliminate the candidate media resources with shorter duration. In some embodiments, the candidate media resources with shorter duration are also referred to as abnormal media resources. A quantity of resource features of a candidate media resource is less than or equal to a threshold of a quantity of resource features. Since candidate media resources with a less quantity of resource features have little reference value, the server can eliminate the candidate media resources with a less quantity of resource features. The threshold of a quantity of times of playing, the threshold of a quantity of times of interaction, the threshold of resource duration, and the threshold of a quantity of resource features are set by a technician according to an actual situation, which is not limited in the embodiments of this application.

In some embodiments, that the candidate first-class objects meet the second target condition means that the candidate first-class objects are in a blocked state.

In some embodiments, that the candidate second-class objects meet the second target condition means at least one of the following cases: The candidate second-class objects are in a blocked state. Viewing duration a day of a candidate second-class object is greater than or equal to a threshold of viewing duration. Since candidate second-class objects with longer viewing duration a day may be abnormal objects and have little reference value, the server can eliminate the candidate second-class objects with longer viewing duration a day. A quantity of object features of a candidate second-class object is less than or equal to a threshold of a quantity of object features. Since candidate second-class objects with a less quantity of object features have little reference value, the server can eliminate the candidate second-class objects with a less quantity of object features. The threshold of viewing duration and the threshold of a quantity of object features are set by a technician according to an actual situation, which is not limited in the embodiments of this application.

In some embodiments, the third target condition means that a viewing proportion corresponding to the candidate association data is less than or equal to a threshold of a viewing proportion. The viewing proportion is a viewing proportion of a media resource when an interaction operation corresponding to the candidate association data is performed. In some embodiments, the threshold of a viewing proportion is negatively correlated with duration of the media resource. For example, a media resource with shorter duration needs to be viewed completely or even viewed more than once before considered to be effectively viewed; a media resource with longer duration only needs to be viewed by a specific proportion to be retained; and for a media resource with longer duration, the threshold of a viewing proportion is set to be lower.

In some embodiments, after preprocessing the initial service data based on the target rule to obtain the target resource service data of the target resource service, the server can preprocess features in the target resource service data. The features in the target resource service data include the resource feature of the media resource, the object feature of the first-class object, and the object feature of the second-class object. Preprocessing the features is encoding or normalizing the features to facilitate processing of the features by the server.

In a possible implementation, the entities in the target resource service further include, in addition to the media resource, the first-class object, and the second-class object, a producer and a resource tag of the media resource. The producer of the media resource is an author or a publisher of the media resource. The resource tag is for indicating information such as a type, a scene, or content of the media resource. In an example, the resource tag is for indicating a classification relationship between the media resource and the type, that is, the media resource is of the type indicated by the resource tag. In another example, the resource tag is for indicating a dependence relationship between the media resource and the content, that is, the media resource is dependent content of the content indicated by the resource tag. For example, the resource tag indicates a television series, and the media resource is an episode of the television series.

302. The server generates the heterogeneous graph based on the entity features of the plurality of entities and the association data between the different types of entities in the plurality of entities, the heterogeneous graph including a plurality of types of nodes, each type of nodes including at least one node, each type of nodes being for representing one type of entities in the target resource service, and a connecting line between different nodes being for representing an association relationship between entities.

In step 302, the heterogeneous graph of the target resource service is generated based on the entity feature of each entity and the association data between the different types of entities. The heterogeneous graph includes the plurality of types of nodes, and each type of nodes represents one type of entities in the target resource service, so a quantity of node types is equal to a quantity of entity types. For example, if the entity types include a media resource, a first-class object, and a second-class object, the node types include a resource node, a first-class object node, and a second-class object node. In addition, the heterogeneous graph includes a plurality of edges, each edge is for connecting two different nodes, and an edge connecting different nodes represents an association relationship between two entities indicated by the two nodes connected by the edge.

When the plurality of entities include a media resource, a first-class object, and a second-class object, the entity features of the plurality of entities include a resource feature of the media resource, an object feature of the first-class object, and an object feature of the second-class object. The heterogeneous graph includes three types of nodes. A first type of nodes is a resource node corresponding to a media resource, a second type of nodes is a first-class object node corresponding to a first-class object, and a third type of nodes is a second-class object node corresponding to a second-class object. In other words, each resource node indicates a media resource, each first-class object node indicates a first-class object, and each second-class object node indicates a second-class object. A quantity of resource nodes is the same as a quantity of media resources. A quantity of first-class object nodes is the same as a quantity of first-class objects. A quantity of second-class object nodes is the same as a quantity of second-class objects. Correspondingly, a node feature of the resource node is a resource feature of the corresponding media resource, a node feature of the first-class object node is an object feature of the corresponding first-class object, and a node feature of the second-class object node is an object feature of the corresponding second-class object. In some embodiments, an entity feature of an entity is also referred to as an attribute of the entity, and a node feature of a node is also referred to as an attribute of the node. In some embodiments, a first-class object node is also referred to as a first-class user node, and a second-class object node is also referred to as a second-class user node.

In the heterogeneous graph, when there is a connecting line between a resource node and an object node, that is, when there is a connecting edge between a resource node and an object node, there is an interaction relationship or a dependence relationship between a media resource corresponding to the resource node and an object corresponding to the object node. The object node includes a first-class object node and a second-class object node. When there is no connecting line between a resource node and an object node, that is, when there is no connecting edge between a resource node and an object node, there is no interaction relationship or dependence relationship between a media resource corresponding to the resource node and an object corresponding to the object node. In some embodiments, there may be a connecting line between resource nodes in the heterogeneous graph. When there is a connecting line between a resource node and another resource node, two media resources corresponding to the two resource nodes are of the same type, or a target interaction behavior is performed on the two resource nodes by the same object.

In a possible implementation, the server generates nodes corresponding to the plurality of entities respectively. A node feature of a node is an entity feature of a corresponding entity, and different types of entities correspond to different types of nodes. The server adds connecting lines between the plurality of generated nodes based on the association data between the different types of entities in the plurality of entities, to obtain the heterogeneous graph. In other words, the server generates a node for indicating each entity, a node feature of the node being an entity feature of the entity indicated by the node, and different types of nodes being for indicating different types of entities; and then adds edges between the different types of generated nodes based on the association data between the different types of entities, to obtain the heterogeneous graph.

An entity feature of an entity is also referred to as representation of the entity. In some embodiments, an entity feature of an entity is stored in the form of a feature matrix. In the heterogeneous graph, entities are in a one-to-one correspondence with nodes, that is, one entity corresponds to one node.

For example, when the plurality of entities include media resources, first-class objects, and second-class objects, the server generates a plurality of resource nodes corresponding to the plurality of media resources. A node feature of each resource node is a resource feature matrix of a corresponding media resource. A node identifier of each resource node is a resource identifier of a corresponding media resource, such as a name or a number of the media resource. A correspondence between the resource node and the media resource can be determined by using the node identifier of the resource node. The server generates a plurality of first-class object nodes corresponding to the plurality of first-class objects. A node feature of each first-class object node is a first-class object feature matrix of a corresponding first-class object. A node identifier of each first-class object node is a first-class object identifier of a corresponding first-class object, such as an account of the first-class object. A correspondence between the first-class object node and the first-class object can be determined by using the node identifier of the first-class object node. The server generates a plurality of second-class object nodes corresponding to the plurality of second-class objects. A node feature of each second-class object node is a second-class object feature matrix of a corresponding second-class object. A node identifier of each second-class object node is a second-class object identifier of a corresponding second-class object, such as an account of the second-class object. A correspondence between the second-class object node and the second-class object can be determined by using the node identifier of the second-class object node. In other words, for each media resource in the heterogeneous graph, a resource node for indicating the media resource is generated. A resource feature matrix of the media resource is used as a node feature of the resource node, and a resource identifier of the media resource is used as a node identifier of the resource node. Similarly, for each first-class object, a first-class object node for indicating the first-class object is generated. A first-class object feature matrix of the first-class object is used as a node feature of the first-class object node, and a first-class object identifier of the first-class object is used as a node identifier of the first-class object node. Similarly, for each second-class object, a second-class object node for indicating the second-class object is generated. A second-class object feature matrix of the second-class object is used as a node feature of the second-class object node, and a second-class object identifier of the second-class object is used as a node identifier of the second-class object node.

The server adds connecting lines between the resource node and the first-class object node and between the resource node and the second-class object node based on the association data between the different types of entities in the plurality of entities, to obtain the heterogeneous graph. In other words, the association data between the different types of entities includes interactive data between the first-class object and the media resource and interactive data between the second-class object and the media resource. In this case, in the heterogeneous graph, the first-class object and the media resource with an association relationship are determined based on the interactive data between the first-class object and the media resource, and a connecting edge is added between the first-class object node for indicating the first-class object and the resource node for indicating the media resource. Similarly, the second-class object and the media resource with an association relationship are determined based on the interactive data between the second-class object and the media resource, and a connecting edge is added between the second-class object node for indicating the second-class object and the resource node for indicating the media resource.

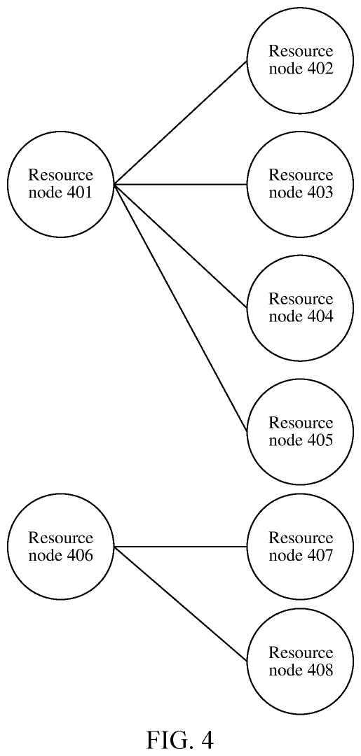

In some embodiments, the server can further add a connecting line between different resource nodes based on the association data. For example, when the target interaction behavior is performed on media resources corresponding to two resource nodes by the same object, the server adds a connecting line between the two resource nodes to represent a relationship of the two resource nodes. For example, referring to FIG. 4, there are connecting lines between a resource node 401 and resource nodes 402-405, and there are connecting lines between a resource node 406 and resource nodes 407-408. In some embodiments, to clearly represent a relationship between nodes by adding a connecting line, a type of a connecting line between resource nodes is different from a type of a connecting line between a resource node and an object node. For example, a type of a connecting line between a resource node and an object node is a first type, and a type of a connecting line between resource nodes is a second type. The server distinguishes between the connecting line of the first type and the connecting line of the second type by using a specific identifier. For example, a type identifier 1 represents the connecting line of the first type, and a type identifier 2 represents the connecting line of the second type. In the heterogeneous graph determined in this manner, there may be a connecting line between nodes of the same type, and there may also be a connecting line between nodes of different types. That is, the heterogeneous graph includes a plurality of types of edges. One type of edges is for connecting a resource node and an object node, and another type of edges is for connecting different resource nodes.

In some embodiments, edges connecting the resource node and the object node are classified into a first-class edge and a second-class edge based on an interaction relationship or a dependence relationship indicated by the association data. The following describes the method for the server to add the connecting lines between the plurality of nodes based on the association data.

In a possible implementation, when the association data represents that any first-class object in the plurality of entities has had the target interaction behavior on any media resource within a target time period, the server adds a first-class connecting line between a first-class object node corresponding to the first-class object and a resource node corresponding to the media resource. A weight of the first-class connecting line is positively correlated with a quantity of the target interaction behavior. That is, when the association data represents that any first-class object has had the target interaction behavior on any media resource within a target time period, a first-class edge is added between a first-class object node indicating the first-class object and a resource node indicating the media resource. A weight of the first-class edge is positively correlated with a quantity of the target interaction behavior.

The target interaction behavior includes viewing, liking, sharing, favoriting, and commenting. The quantity of the target interaction behavior is a quantity of the foregoing behaviors completed on the media resource by the object. For example, when the first-class object has only viewed the media resource within the target time period, the weight of the first-class connecting line is set to 0.5. When the first-class object has viewed and liked the media resource within the target time period, the weight of the first-class connecting line is set to 0.6. The first-class connecting line is for connecting the object node and the resource node, indicating that the object corresponding to the object node has had the target interaction behavior on the media resource corresponding to the resource node within the target time period. The object node includes a first-class object node and a second-class object node. The target time period is set by a technician according to an actual situation, which is not limited in the embodiments of this application.

In this implementation, the server adds the first-class connecting line between the first-class object node and the resource node to represent the relationship between the first-class object node and the resource node, uses the weight of the first-class connecting line to represent the quantity of the target interaction behavior, and obtains accurate results during subsequent graph convolution based on the first-class connecting line and the weight of the first-class connecting line.

In a possible implementation, when the association data represents that any second-class object in the plurality of entities has had the target interaction behavior on any media resource within the target time period, the server adds the first-class connecting line between a second-class object node corresponding to the second-class object and a resource node corresponding to the media resource. That is, when the association data represents that any second-class object has had the target interaction behavior on any media resource within the target time period, a first-class edge is added between a second-class object node indicating the second-class object and a resource node indicating the media resource. A weight of the first-class edge is positively correlated with a quantity of the target interaction behavior.

In this implementation, the server adds the first-class connecting line between the second-class object node and the resource node to represent the relationship between the second-class object node and the resource node, uses the weight of the first-class connecting line to represent the quantity of the target interaction behavior, and obtains accurate results during subsequent graph convolution based on the first-class connecting line and the weight of the first-class connecting line.

In a possible implementation, when the association data represents that a producer of any media resource in the plurality of entities is any first-class object in the plurality of entities, the server adds a second-class connecting line between a first-class object node corresponding to the first-class object and a resource node corresponding to the media resource. The second-class connecting line is for connecting the object node and the resource node, indicating that the object corresponding to the object node and the media resource corresponding to the resource node have a relationship of producing and being produced, which can enhance the connection between the object node and the resource node, thereby increasing the accuracy of subsequent graph convolution. That is, when the association data represents that a producer of any media resource is any first-class object, a second-class edge is added between a first-class object node indicating the first-class object and a resource node indicating the media resource.

In a possible implementation, when the association data represents that a producer of any media resource in the plurality of entities is any second-class object in the plurality of entities, the server adds the second-class connecting line between a second-class object node corresponding to the second-class object and a resource node corresponding to the media resource. The second-class connecting line is for connecting the object node and the resource node, indicating that the object corresponding to the object node and the media resource corresponding to the resource node have a relationship of producing and being produced, which can enhance the connection between the object node and the resource node, thereby increasing the accuracy of subsequent graph convolution. That is, when the association data represents that a producer of any media resource is any second-class object, a second-class edge is added between a second-class object node indicating the second-class object and a resource node indicating the media resource.

The server repeats the step of adding connecting lines between nodes based on the association data to obtain the heterogeneous graph. The foregoing process is described by using an example in which the entities in the target resource service include the media resource, the first-class object, and the second-class object. The following process is described by using an example in which the entities in the target resource service further include other types of entities.

In some embodiments, the entities in the target resource service further include, in addition to the media resource, the first-class object, and the second-class object, at least one of a producer and a resource tag of the media resource. The producer is not the first-class object or the second-class object, but an object that only produces content and does not consume the content. When the entities in the target resource service further include the producer and the resource tag of the media resource, the heterogeneous graph includes five types of nodes. A first type of nodes is a resource node corresponding to the media resource. A second type of nodes is a first-class object node corresponding to the first-class object. A third type of nodes is a second-class object node corresponding to the second-class object. A fourth type of nodes is a producer node corresponding to the producer of the media resource. A fifth type of nodes is a tag node corresponding to the resource tag of the media resource. A quantity of resource nodes is the same as a quantity of media resources. A quantity of first-class object nodes is the same as a quantity of first-class objects. A quantity of second-class object nodes is the same as a quantity of second-class objects. A quantity of producer nodes is the same as a quantity of producers of the media resource. A quantity of tag nodes is the same as a quantity of resource tags of the media resource. Correspondingly, a node feature of the resource node is a resource feature of the corresponding media resource, a node feature of the first-class object node is an object feature of the corresponding first-class object, a node feature of the second-class object node is an object feature of the corresponding second-class object, a node feature of the producer node is a producer feature of the corresponding producer, and a node feature of the tag node is content of the corresponding to the resource tag. In some embodiments, the producer feature is similar to the object feature and includes at least one of a gender, a location, online time, and a following list of the corresponding producer. Certainly, the server also has to obtain and use the producer feature with permission of the producer.

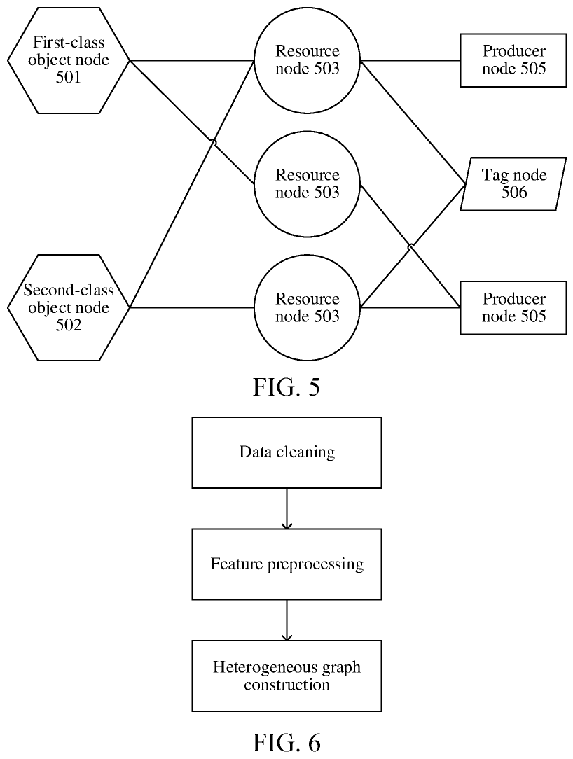

In the heterogeneous graph, when there is a connecting line between a resource node and an object node, there is an interaction relationship between a media resource corresponding to the resource node and an object corresponding to the object node, that is, the object corresponding to the object node has had the target interaction behavior on the media resource corresponding to the resource node, or a producer of the media resource is the object. The object node includes a first-class object node and a second-class object node. When there is no connecting line between a resource node and an object node, there is no interaction relationship between a media resource corresponding to the resource node and an object corresponding to the object node, that is, the object corresponding to the object node has not had the target interaction behavior on the media resource corresponding to the resource node, and a producer of the media resource is not the object. When there is a connecting line between a resource node and a producer node, there is a production relationship between a media resource corresponding to the resource node and a producer corresponding to the producer node, that is, the media resource is created or published by the producer. When there is no connecting line between a resource node and a producer node, there is no production relationship between a media resource corresponding to the resource node and a producer corresponding to the producer node. When there is a connecting line between a resource node and a tag node, there is a dependence relationship between a media resource corresponding to the resource node and a resource tag corresponding to the tag node, that is, the resource tag is a resource tag of the media resource. When there is no connecting line between a resource node and a tag node, there is no dependence relationship between a media resource corresponding to the resource node and a resource tag corresponding to the tag node. When there is a connecting line between an object node and a producer node, there is a following relationship between an object corresponding to the object node and a producer corresponding to the producer node, that is, the object follows the producer. When there is no connecting line between an object node and a producer node, there is no following relationship between an object corresponding to the object node and a producer corresponding to the producer node. For example, FIG. 5 provides a schematic diagram of a heterogeneous graph. FIG. 5 includes a first-class object node 501, a second-class object node 502, a resource node 503, a producer node 505, and a tag node 506.

In a possible implementation, the server generates a plurality of resource nodes corresponding to the plurality of media resources. A node feature of each resource node is a resource feature matrix of a corresponding media resource. A node identifier of each resource node is a resource identifier of a corresponding media resource. The server generates a plurality of first-class object nodes corresponding to the plurality of first-class objects. A node feature of each first-class object node is a first-class object feature matrix of a corresponding first-class object. A node identifier of each first-class object node is a first-class object identifier of a corresponding first-class object. The server generates a plurality of producer nodes corresponding to producers of a plurality of media resources. A node feature of each producer node is a producer feature of a corresponding producer. A node identifier of each producer node is a producer identifier of a corresponding producer, such as an account of the producer. A correspondence between the producer node and the producer can be determined by using the node identifier of the producer node. The server generates a plurality of tag nodes corresponding to resource tags of the plurality of media resources. A node feature of each tag node is content of a corresponding resource tag. A node identifier of each tag node is also content of a corresponding resource tag. The server adds connecting lines between the resource node and the first-class object node, between the resource node and the producer node, between the resource node and the tag node, and between the first-class object node and the producer node based on the association data between the plurality of entities, to obtain the heterogeneous graph. In the heterogeneous graph determined in this manner, there is a connecting line between nodes of different types, and there is no connecting line between nodes of the same type.

For example, when the association data indicates that there is a dependence relationship between any producer and any media resource, a third-class connecting line is added between a producer node corresponding to the producer and a resource node corresponding to the media resource, that is, a third-class edge is added between a producer node indicating the producer and a resource node indicating the media resource. When the association data between the plurality of entities indicates that there is a dependence relationship between any resource tag and any media resource, a fourth-class connecting line is added between a tag node corresponding to the resource tag and a resource node corresponding to the media resource, that is, a fourth-class edge is added between a tag node indicating the resource tag and a resource node indicating the media resource. The step of adding connecting lines between nodes based on the association data between the plurality of entities is repeated to obtain the heterogeneous graph.

The third-class connecting line is for connecting the producer node and the resource node, indicating that the producer corresponding to the producer node is a producer of the media resource corresponding to the resource node. The fourth-class connecting line is for connecting the tag node and the resource node, indicating that the tag of the tag node is a tag of the media resource corresponding to the resource node. With reference to the first-class connecting line and the second-class connecting line described above, relationships between nodes can be more accurately reflected in the heterogeneous graph through a plurality of types of connecting lines.

The foregoing process is described by using an example in which the entities in the target resource service include five types of entities: the media resource, the first-class object, the second-class object, the producer of the media resource, and the resource tag of the media resource. When the entities in the target resource service include four types of entities: the media resource, the first-class object, the second-class object, and the producer of the media resource, or the entities in the target resource service include four types of entities: the media resource, the first-class object, the second-class object, and the resource tag of the media resource, the manner in which the server generates the heterogeneous graph belongs to the same inventive concept as the manner described above, with corresponding reduction of types of created nodes and connecting lines, and details are not described herein again.

In addition, when the entities in the target resource service further include, in addition to the five types of entities: the media resource, the first-class object, the second-class object, the producer of the media resource, and the resource tag of the media resource, other types of entities, the server correspondingly generates nodes and adds connecting lines, and details are not described herein again.

The following describes steps 301 and 302 with reference to FIG. 6. Referring to FIG. 6, the server performs data cleaning on the initial service data to obtain target service data. The server preprocesses features in the target service data. The server constructs the heterogeneous graph based on the target service data with the features preprocessed. Steps 301 and 302 are optional steps. The server can also directly obtain a generated heterogeneous graph and perform step 303 based on the heterogeneous graph, which is not limited in the embodiments of this application.

303. The server performs graph convolution on the heterogeneous graph through a graph neural network based on a plurality of types of meta-paths of a plurality of nodes in the heterogeneous graph, to obtain initial representation information of a first-class object node and initial representation information of a second-class object node in the plurality of nodes, the first-class object node being corresponding to the first-class object, the second-class object node being corresponding to the second-class object, and any one of the plurality of types of meta-paths being for representing one connection manner between different types of nodes in the heterogeneous graph.

In step 303, graph convolution is performed on the heterogeneous graph through the graph neural network based on the plurality of types of meta-paths of the plurality of nodes in the heterogeneous graph, to obtain the initial representation information of the first-class object node and the initial representation information of the second-class object node. The first-class object node indicates the first-class object, and the second-class object node indicates the second-class object. The graph neural network is the graph sample and aggregate (Graph Sage) network or graph attention network (GAT), and may be certainly another type of graph neural network with the development of science and technology, which is not limited in the embodiments of this application. A meta-path connects a plurality of nodes, and there is a connecting line between the nodes connected by the meta-path, that is, there is an association relationship between the nodes connected by the meta-path. That graph convolution is performed on the heterogeneous graph based on the plurality of types of meta-paths of the plurality of nodes in the heterogeneous graph means that graph convolution is performed based on the meta-path corresponding to each node in the heterogeneous graph to obtain the initial representation information of each node. Certainly, one node may correspond to a plurality of meta-paths. The initial representation information of a node is different from the node feature of the node. The node feature is given to the node when the heterogeneous graph is generated, while the initial representation information is representation information obtained after processing through the graph neural network. The node feature of the first-class object node and the node feature of a neighbor node of the first-class object node are fused into the initial representation information. Since the initial representation information of a node is obtained by performing graph convolution based on the meta-path of the node, the initial representation information is actually aggregated representation information including the node features of the nodes through which the meta-path passes.

In a possible implementation, for any first-class object node in the plurality of nodes, the server performs graph convolution on the first-class object node through the graph neural network based on a plurality of meta-paths of the first-class object node, to obtain the initial representation information of the first-class object node. All end points of the plurality of meta-paths of the first-class object node are the first-class object node.

The plurality of meta-paths of the first-class object node represents not all meta-paths of the first-class object node, but a group of meta-paths of the first-class object node. A group of meta-paths includes a plurality of meta-paths, and a plurality of groups of meta-paths include all the meta-paths of the first-class object node. The meta-paths of the first-class object node are grouped by a technician according to an actual situation or are randomly grouped by the server, which is not limited in the embodiments of this application.

A type of a meta-path is determined by an end point of the meta-path, that is, meta-paths can be divided into different types based on nodes at end points of the meta-paths. For example, if a node at an end point of a meta-path is the first-class object node, a type of the meta-path is the meta-path of the first-class object node. If a node at an end point of another meta-path is the second-class object node, a type of the meta-path is the meta-path of the second-class object node. Alternatively, a type of a meta-path is determined by a sequence of nodes through which the meta-path passes, and the sequence of the nodes is a sequence of node types. For example, if a meta-path passes through a first-class object node A, a resource node B, and a first-class object node C in sequence, and another meta-path passes through a first-class object node D, a resource node E, and the first-class object node C in sequence, the two meta-paths are of the same type, which are the meta-paths that pass through the first-class object node, the resource node, and the first-class object node in sequence, and the two meta-paths are both the meta-paths of the first-class object node C. If the resource node is abbreviated to V and the first-class object node is abbreviated to U₁, the meta-path of the first-class object is U₁→V→U₁. End points of a plurality of meta-paths of the first-class object node are all the first-class object node. Nodes through which the plurality of meta-paths pass are different except for the first-class object node. Certainly, the foregoing process is described by using an example in which the meta-path of the first-class object node passes through three nodes. In other possible implementations, the meta-path of the first-class object node further passes through more nodes, for example, passes through five nodes U₁→V→U₁→V→U₁ or passes through seven nodes U₁→V→U₁→V→U₁→V→U₁, which is not limited in the embodiments of this application.

For example, the server fuses node features of nodes through which the plurality of meta-paths of the first-class object node pass and a node feature of the first-class object node based on the graph neural network, to obtain the initial representation information of the first-class object node.

For example, for a meta-path of the first-class object node, the meta-path passes through three nodes: another first-class object node, a resource node, and the first-class object node. When graph convolution is performed through the meta-path based on the graph neural network, a node feature of the another first-class object node and a node feature of the resource node are fused to obtain a first fused feature of the resource node. The first fused feature of the resource node and a node feature of the first-class object node are fused to obtain representation information of the first-class object node on the meta-path. In some embodiments, when graph convolution is performed through the meta-path based on the graph neural network, a type and a weight of a connecting line between the nodes on the meta-path may be used as references, that is, node features of two nodes are fused based on a type and a weight of a connecting line between the two nodes on the meta-path. The type of the connecting line corresponds to a baseline weight, and the weight of the connecting line is an additional weight added on the baseline weight. Weighted summation is performed in a direction from a start point to an end point of the meta-path. For example, there is a first-class connecting line between a first-class object node and a resource node, a weight of the first-class connecting line is 0.5, the first-class object node is close to the start point of the meta-path, and the resource node is close to the end point of the meta-path. The server determines that a baseline weight corresponding to the first-class connecting line is 0.9. When the node feature of the first-class object node and the node feature of the resource node are fused, the node feature of the first-class object node is multiplied by the baseline weight 0.9 and then multiplied by the weight 0.5 of the first-class connecting line to obtain a result, and the result of the two times of multiplication is added to the node feature of the resource node. The server fuses representation information of the first-class object node on a plurality of meta-paths to obtain initial representation information of the first-class object node. The method for the server to determine the representation information of the first-class object node on the plurality of meta-paths belongs to the same inventive concept as the foregoing description, and details are not described herein again.

In some embodiments, a node through which a meta-path of the first-class object node passes is also referred to as a reference node of the first-class object node. The reference node is a neighbor node of the first-class object node. The neighbor node includes a first-order neighbor node, a second-order neighbor node, . . . , and an Nth-order neighbor node, where N is a positive integer. When the reference node is a first-order neighbor node of the first-class object node, the reference node is directly connected to the first-class object node, that is, there is a connecting line between the reference node and the first-class object node. When the reference node is a second-order neighbor node of the first-class object node, the reference node is indirectly connected to the first-class object node by another node, that is, there is another node between the reference node and the first-class object node, and there are a connecting line between the reference node and the another node and a connecting line between the first-class object node and the another node. When a meta-path connects three nodes, the meta-path connects a first-order neighbor node and a second-order neighbor node of a node at a start point.

In some embodiments, when the server performs graph convolution through the graph neural network based on a plurality of meta-paths of nodes in the heterogeneous graph, parameters of a graph convolutional layer corresponding to each meta-path are not shared. Graph convolution operators include the GraphSage, GAT, graph convolutional network (GCN), and the like. In some embodiments, a graph convolutional layer in the foregoing network is improved by changing the original mean aggregator to mean pooling aggregator, to improve a feature extraction capability of the network for neighbor nodes.

To describe the foregoing implementation more clearly, the following describes the foregoing implementation from another perspective based on the foregoing description of the reference node.

In a possible implementation, a meta-path of the first-class object node passes through a second reference node, a first reference node, and the first-class object node in sequence. The first-class object node is an end point of the meta-path. The first reference node is a midpoint of the meta-path. The second reference node is a start point of the meta-path. The first reference node is a first-order neighbor node of the first-class object node. The second reference node is a second-order neighbor node of the first-class object node. The server fuses a node feature of the second reference node and a node feature of the first reference node based on the graph neural network to obtain a first fused feature. The server fuses the first fused feature and a node feature of the first-class object node based on the graph neural network to obtain representation information of the first-class object node on the meta-path. The server fuses representation information of the first-class object node on a plurality of meta-paths to obtain initial representation information of the first-class object node.

The following describes the method for the server to fuse the representation information of the first-class object node on the plurality of meta-paths to obtain the initial representation information of the first-class object node. The initial representation information of the first-class object node is an initial embedding vector of the first-class object node.

In a possible implementation, the server performs weighted summation on the representation information of the first-class object node on the plurality of meta-paths to obtain the initial representation information of the first-class object node. The weight for weighted summation is set by a technician according to an actual situation, which is not limited in the embodiments of this application.

In a possible implementation, the server encodes the representation information of the first-class object node on the plurality of meta-paths based on an attention mechanism to obtain the initial representation information of the first-class object node. For example, the server obtains a plurality of attention weights between the plurality of pieces of representation information. The server fuses the plurality of pieces of representation information based on the plurality of attention weights to obtain the initial representation information of the first-class object node.

For example, the representation information includes two pieces of representation information. The server performs linear transformation on a first piece of representation information by using three linear transformation matrices to obtain a first query matrix Q₁, a first key matrix K₁, and a first value matrix V₁ of the first piece of representation information. The three linear transformation matrices are matrices obtained in a model training process. The server performs linear transformation on a second piece of representation information by using the three linear transformation matrices to obtain a second query matrix Q₂, a second key matrix K₂, and a second value matrix V₂ of the second piece of representation information. The server obtains a first attention weight of the first piece of representation information on the second piece of representation information based on the first query matrix Q₁ of the first piece of representation information and the second key matrix K₂ of the second piece of representation information. The server obtains a second attention weight of the second piece of representation information on the first piece of representation information based on the second query matrix Q₂ of the second piece of representation information and the first key matrix K₁ of the first piece of representation information. The server performs weighted summation on the first value matrix V₁ and the second value matrix V₂ based on the first attention weight and the second attention weight to obtain the initial representation information of the first-class object node. The server can obtain the attention weight by multiplying the query matrix and the key matrix.

The foregoing process is described by using an example in which the representation information includes two pieces of representation information. The implementation process of more pieces of representation information belongs to the same inventive concept as the foregoing description, and details are not described herein again.

In some embodiments, when the server fuses the representation information of the first-class object node on the plurality of meta-paths to obtain the initial representation information of the first-class object node, the server can multiply the plurality of pieces of representation information by a mask matrix to obtain a plurality of pieces of first candidate representation information. The server fuses the plurality of pieces of first candidate representation information to obtain the initial representation information of the first-class object node. The mask matrix is a matrix including 0 and 1. Locations of 0 and 1 in the mask matrix are randomly generated by the server. After the representation information is multiplied by the mask matrix, some information in the representation information can be randomly hidden, which can improve the robustness of a model.

In some embodiments, since forms of the representation information may be different, the representation information of nodes is normalized to be consistent. Correspondingly, the server normalizes a plurality of pieces of representation information to obtain a plurality of pieces of second candidate representation information. The server fuses the plurality of pieces of second candidate representation information to obtain the initial representation information of the first-class object node. Normalization methods include any one of soft maximum (SoftMax), linear rectification (Relu), or S-shaped growth curves (Sigmoid), which is not limited in the embodiments of this application.

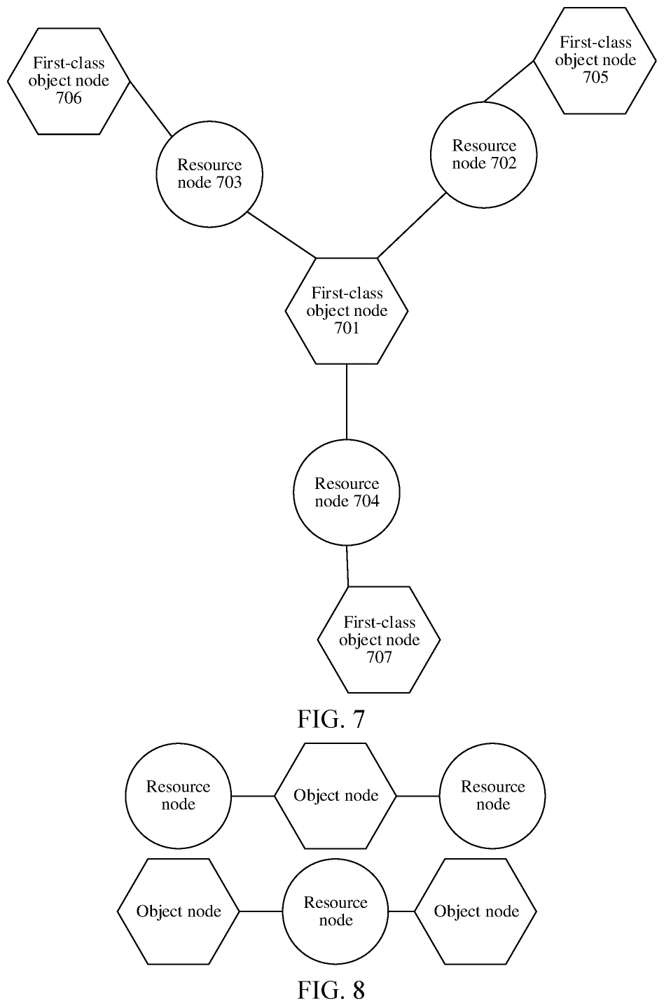

The following describes the process for the server to fuse the representation information of the first-class object node on the plurality of meta-paths to obtain the initial representation information of the first-class object node with reference to FIG. 7. FIG. 7 includes the first-class object node 701, three resource nodes 702-704, and three other first-class object nodes 705-707. In FIG. 7, the first-class object node 705, the resource node 702, and the first-class object node 701 form a meta-path. When graph convolution is performed based on the meta-path, aggregation is performed in the direction of the first-class object node 705→the resource node 702→the first-class object node 701 to obtain representation information of the first-class object node on the meta-path. The first-class object node 706, the resource node 703, and the first-class object node 701 form another meta-path. When graph convolution is performed based on the meta-path, aggregation is performed in the direction of the first-class object node 706→the resource node 703→the first-class object node 701 to obtain representation information of the first-class object node on the meta-path. The first-class object node 707, the resource node 704, and the first-class object node 701 form another meta-path. When graph convolution is performed based on the meta-path, aggregation is performed in the direction of the first-class object node 707→the resource node 704→the first-class object node 701 to obtain representation information of the first-class object node on the meta-path. Then, the representation information of the first-class object node 701 on the three meta-paths is fused to obtain initial representation information of the first-class object node 701. The fusion manner may be any one or more of the following: weighted summation, encoding based on an attention mechanism, mask processing, normalization, and the like.

After the server obtains the initial representation information of the first-class object node, the following describes the method for the server to obtain initial representation information of a second-class object node.

In a possible implementation, for any second-class object node in the plurality of nodes, the server performs graph convolution on the second-class object node through the graph neural network based on a plurality of meta-paths of the second-class object node, to obtain the initial representation information of the second-class object node. All end points of the plurality of meta-paths of the second-class object node are the second-class object node.

The plurality of meta-paths of the second-class object node represents not all meta-paths of the second-class object node, but a group of meta-paths of the second-class object node. A group of meta-paths includes a plurality of meta-paths, and a plurality of groups of meta-paths include all the meta-paths of the second-class object node. The meta-paths of the second-class object node are grouped by a technician according to an actual situation or are randomly grouped by the server, which is not limited in the embodiments of this application.

A type of a meta-path is determined by an end point of the meta-path, that is, meta-paths can be divided into different types based on nodes at end points of the meta-paths. For example, if a node at an end point of a meta-path is the second-class object node, a type of the meta-path is the meta-path of the second-class object node. If a node at an end point of another meta-path is the second-class object node, a type of the meta-path is the meta-path of the second-class object node. Alternatively, a type of a meta-path is determined by a sequence of nodes through which the meta-path passes, and the sequence of the nodes is a sequence of node types. If the resource node is abbreviated to V and the second-class object node is abbreviated to U₂, the meta-path of the second-class object is U₂→V→U₂. End points of a plurality of meta-paths of the second-class object node are all the second-class object node. Nodes through which the plurality of meta-paths pass are different except for the second-class object node. Certainly, the foregoing process is described by using an example in which the meta-path of the second-class object node passes through three nodes. In other possible implementations, the meta-path of the second-class object node further passes through more nodes, for example, passes through five nodes U₂→V→U₂→V→U₂ or passes through seven nodes U₂→V→U₂→V→U₂→V→U₂, which is not limited in the embodiments of this application.

For example, the server fuses node features of nodes through which the plurality of meta-paths of the second-class object node pass and a node feature of the second-class object node based on the graph neural network, to obtain the initial representation information of the second-class object node.

For example, for a meta-path of the second-class object node, the meta-path passes through three nodes: another second-class object node, a resource node, and the second-class object node. When graph convolution is performed through the meta-path based on the graph neural network, a node feature of the another second-class object node and a node feature of the resource node are fused to obtain a first fused feature of the resource node. The first fused feature of the resource node and a node feature of the second-class object node are fused to obtain representation information of the second-class object node on the meta-path. In some embodiments, when graph convolution is performed through the meta-path based on the graph neural network, a type and a weight of a connecting line between the nodes on the meta-path may be used as references, that is, node features of two nodes are fused based on a type and a weight of a connecting line between the two nodes on the meta-path. The type of the connecting line corresponds to a baseline weight, and the weight of the connecting line is an additional weight added on the baseline weight. Weighted summation is performed in a direction from a start point to an end point of the meta-path. For example, there is a first-class connecting line between a second-class object node and a resource node, a weight of the first-class connecting line is 0.5, the second-class object node is close to the start point of the meta-path, and the resource node is close to the end point of the meta-path. The server determines that a baseline weight corresponding to the first-class connecting line is 0.9. When the node feature of the second-class object node and the node feature of the resource node are fused, the node feature of the second-class object node is multiplied by the baseline weight 0.9 and then multiplied by the weight 0.5 of the first-class connecting line to obtain a result, and the result of the two times of multiplication is added to the node feature of the resource node. The server fuses representation information of the second-class object node on a plurality of meta-paths to obtain initial representation information of the second-class object node. The method for the server to determine the representation information of the second-class object node on the plurality of meta-paths belongs to the same inventive concept as the foregoing description, and details are not described herein again.

In some embodiments, a node through which a meta-path of the second-class object node passes is also referred to as a reference node of the second-class object node. The reference node is a neighbor node of the second-class object node. The neighbor node includes a first-order neighbor node, a second-order neighbor node, . . . , and an Nth-order neighbor node, where N is a positive integer. When the reference node is a first-order neighbor node of the second-class object node, the reference node is directly connected to the second-class object node, that is, there is a connecting line between the reference node and the second-class object node. When the reference node is a second-order neighbor node of the second-class object node, the reference node is indirectly connected to the second-class object node by another node, that is, there is another node between the reference node and the second-class object node, and there are a connecting line between the reference node and the another node and a connecting line between the second-class object node and the another node. When a meta-path connects three nodes, the meta-path connects a first-order neighbor node and a second-order neighbor node of a node at a start point.

To describe the foregoing implementation more clearly, the following describes the foregoing implementation from another perspective based on the foregoing description of the reference node.

In a possible implementation, a meta-path of the second-class object node passes through a second reference node, a first reference node, and the second-class object node in sequence. The second-class object node is an end point of the meta-path. The first reference node is a midpoint of the meta-path. The second reference node is a start point of the meta-path. The first reference node is a first-order neighbor node of the second-class object node. The second reference node is a second-order neighbor node of the second-class object node. The server fuses a node feature of the second reference node and a node feature of the first reference node based on the graph neural network to obtain a first fused feature. The server fuses the first fused feature and a node feature of the second-class object node based on the graph neural network to obtain representation information of the second-class object node on the meta-path. The server fuses representation information of the second-class object node on a plurality of meta-paths to obtain initial representation information of the second-class object node.

The method for the server to fuse the representation information of the second-class object node on the plurality of meta-paths to obtain the initial representation information of the second-class object node belongs to the same inventive concept as the method for the server to fuse the representation information of the first-class object node on the plurality of meta-paths to obtain the initial representation information of the first-class object node, and details are not described herein again.

In some embodiments, for a resource node in the heterogeneous graph, the server can also obtain initial representation information of the resource node through the foregoing implementation, which belongs to the same inventive concept as the method for obtaining the initial representation information of the object node, and details are not described herein again.

For example, FIG. 8 is a schematic diagram of meta-paths in ICF and UCF scenarios. An upper panel of FIG. 8 shows a meta-path in an ICF scenario, and a form of the meta-path in the ICF scenario is V-U-V (media resource-object-media resource). A lower panel of FIG. 8 shows a meta-path in a UCF scenario, and a form of the meta-path in the UCF scenario is U-V-U (object-media resource-object).

304. The server fuses the initial representation information of the first-class object node and the initial representation information of the second-class object node based on the connecting line between the plurality of nodes, to obtain target representation information of the first-class object node, the target representation information being for recommending media resources to the first-class object.

In step 304, the initial representation information of the first-class object node and the initial representation information of the second-class object node are fused based on an edge connecting different nodes in the heterogeneous graph, to obtain the target representation information of the first-class object node.

In a possible implementation, the server determines, for any first-class object node in the plurality of nodes, at least one relevant second-class object node and at least one irrelevant second-class object node of the first-class object node based on a connecting line between the first-class object node and a resource node. The second-class object corresponding to the relevant second-class object node and the first-class object have had the target interaction behavior on the same media resource, and media resources on which the second-class object corresponding to the irrelevant second-class object node has had the target interaction behavior are all different from media resources on which the first-class object has had the target interaction behavior. The server fuses the initial representation information of the first-class object node, initial representation information of the at least one relevant second-class object node, and initial representation information of the at least one irrelevant second-class object node, to obtain fused representation information of the first-class object node. The server adjusts the fused representation information of the first-class object node based on the initial representation information of the at least one relevant second-class object node, to obtain the target representation information of the first-class object node.

In other words, for any first-class object node, a relevant second-class object node and an irrelevant second-class object node of the first-class object node are determined based on an edge between the first-class object node and a resource node. The second-class object indicated by the relevant second-class object node and the first-class object indicated by the first-class object node have had the target interaction behavior on the same media resource, and media resources on which the second-class object indicated by the irrelevant second-class object node has had the target interaction behavior are all different from media resources on which the first-class object indicated by the first-class object node has had the target interaction behavior. Next, the initial representation information of the first-class object node, initial representation information of the relevant second-class object node, and initial representation information of the irrelevant second-class object node are fused, to obtain fused representation information of the first-class object node. Then, the fused representation information of the first-class object node is adjusted based on the initial representation information of the relevant second-class object node, to obtain the target representation information of the first-class object node.

In this implementation, at least one relevant second-class object node and at least one irrelevant second-class object node of a first-class object node can be determined, and initial representation information of the first-class object node, initial representation information of the at least one relevant second-class object node, and initial representation information of the at least one irrelevant second-class object node are fused, to obtain fused representation information of the first-class object node. Then, the fused representation information of the first-class object node is adjusted based on the initial representation information of the at least one relevant second-class object node, to obtain target representation information of the first-class object node. The information of the relevant second-class object node and the irrelevant second-class object node is fused into the target representation information, and the target representation information is more abundant and accurate after the adjustment based on the relevant second-class object node.

To describe the foregoing implementation more clearly, the following describes the foregoing implementation in three parts.

Part 1. The server determines at least one relevant second-class object node and at least one irrelevant second-class object node of the first-class object node based on a connecting line between the first-class object node and a resource node.

The relevant second-class object node and the irrelevant second-class object node of the first-class object node are both second-class object nodes in the heterogeneous graph.

In a possible implementation, the server determines at least one relevant resource node of the first-class object node based on a connecting line between the first-class object node and a resource node. The relevant resource node is a resource node having a connecting line with the first-class object node. The server determines at least one relevant second-class object node of the first-class object node based on the at least one relevant resource node of the first-class object node. There is a connecting line between the relevant second-class object node and the relevant resource node. The server determines at least one irrelevant resource node of the first-class object node based on a connecting line between the first-class object node and a resource node. The irrelevant resource node is a resource node having no connecting line with the first-class object node. The server determines at least one irrelevant second-class object node of the first-class object node based on the at least one irrelevant resource node of the first-class object node. There is no connecting line between the irrelevant second-class object node and the irrelevant resource node. That is, for any first-class object node in the heterogeneous graph, all relevant resource nodes having connecting edges with the first-class object node are found to find all relevant second-class object nodes having connecting edges with any relevant resource node. Similarly, all irrelevant resource nodes having no connecting edges with the first-class object node are found to find all irrelevant second-class object nodes having connecting edges with any irrelevant resource node.

In this implementation, the server can obtain the relevant second-class object node and the irrelevant second-class object node of the first-class object node based on the connecting line between the first-class object node and the resource node, which has high efficiency.

In a possible implementation, the server determines, based on a connecting line between the first-class object node and a resource node and connecting lines between a plurality of second-class object nodes and a resource node, at least one relevant second-class object node and at least one irrelevant second-class object node of the first-class object node from the plurality of second-class object nodes. A resource node connected to the at least one relevant second-class object node is connected to the first-class object node. A resource node connected to the at least one irrelevant second-class object node is not connected to the first-class object node.

In this implementation, the server can filter out the relevant second-class object node and the irrelevant second-class object node of the first-class object node from the plurality of second-class object nodes based on the connecting line between the first-class object node and the resource node and the connecting line between the second-class object node and the resource node, which has high efficiency.

For example, the server determines a plurality of reference node pairs based on a connecting line between the first-class object node and a resource node. Each reference node pair includes the first-class object node and a connected resource node. The server determines a plurality of candidate node pairs based on connecting lines between a plurality of second-class object nodes and a resource node. Each candidate node pair includes a second-class object node and a connected resource node. The server determines, from the plurality of candidate node pairs, a target candidate node pair having the same resource node as a reference node pair. The server determines a second-class object node in the target candidate node pair as a relevant second-class object node of the first-class object node, and determines a second-class object node in another candidate node pair as an irrelevant second-class object node of the first-class object node.

In some embodiments, a node in the reference node pair is a node through which a meta-path of the first-class object node passes.

Part 2. The server fuses the initial representation information of the first-class object node, initial representation information of the at least one relevant second-class object node, and initial representation information of the at least one irrelevant second-class object node, to obtain fused representation information of the first-class object node.

In some embodiments, a second-class object corresponding to the relevant second-class object node is also referred to as an object with the same behavior as a first-class object corresponding to the first-class object node. That is, the second-class object and the first-class object have performed the target interaction behavior on the same media resource. A second-class object corresponding to the irrelevant second-class object node is also referred to as an object with a different behavior from a first-class object corresponding to the first-class object node. That is, the second-class object and the first-class object have not performed the target interaction behavior on the same media resource.

In a possible implementation, the server adds a mask in the initial representation information of the first-class object node to obtain reference representation information of the first-class object node. The server performs weighted summation on the reference representation information of the first-class object node, initial representation information of the at least one relevant second-class object node, and initial representation information of the at least one irrelevant second-class object node, to obtain fused representation information of the first-class object node.

In this implementation, the initial representation information of the relevant second-class object node and the initial representation information of the irrelevant second-class object node are fused to obtain representation information that includes information of the second-class object nodes and is more favorable to the first-class object node. The representation information of the first-class object node includes information of the first-class object. The relevant second-class object node includes information of intersection of the first-class object and the second-class object. The irrelevant second-class object node includes information of difference between the first-class object and the second-class object. In this case, the addition of the mask in the reference representation information of the first-class object node can weaken the reference representation information of the first-class object node in the fused representation information obtained, so that the initial representation information of the relevant second-class object node and the initial representation information of the irrelevant second-class object node have a higher degree of importance in the fused representation information, which increases the accuracy of subsequent video recommendation.

Part 3. The server adjusts the fused representation information of the first-class object node based on the initial representation information of the at least one relevant second-class object node, to obtain the target representation information of the first-class object node.

In a possible implementation, the server inputs the initial representation information of the at least one relevant second-class object node to a target classifier, and the target classifier outputs an object type of the second-class object indicated by the relevant second-class object node. The server inputs the fused representation information of the first-class object node to the target classifier, and the target classifier outputs an object type of the first-class object indicated by the first-class object node. The server adjusts the fused representation information of the first-class object node based on difference information between the object type of the second-class object and the object type of the first-class object, to obtain the target representation information of the first-class object node.

The target classifier includes a fully connected layer and a normalization layer. After inputting the representation information to the target classifier, the server performs full connection on the representation information through the fully connected layer of the target classifier and performs normalization through the normalization layer, to finally output the object type. The representation information includes the initial representation information of the relevant second-class object node and the fused representation information of the first-class object node.

In this implementation, since the fused representation information of the first-class object node is usually sparse, the target classifier causes the fused representation information of the first-class object node to learn mapping into the initial representation information of the relevant second-class object node, to obtain the target representation information of the first-class object node, which can reflect features of the first-class object more completely. This manner is also a method of transfer learning to transfer the information of the second-class object to the first-class object.

305. The server stores representation information of each of a plurality of nodes in the heterogeneous graph.

The plurality of nodes include a resource node, a first-class object node, and a second-class object node. The representation information of each of the plurality of nodes includes initial representation information of the resource node, target representation information of the first-class object node, and initial representation information of the second-class object node. For manners for obtaining the initial representation information of the resource node and the initial representation information of the second-class object node, refer to the related description of step 303. For a manner for obtaining the target representation information of the first-class object node, refer to the related description of step 304.

In a possible implementation, the server stores the initial representation information of the resource node of the plurality of nodes in a resource database, and stores the target representation information of the first-class object node and the initial representation information of the second-class object node of the plurality of nodes in an object database. When the object is a user, the object database is also referred to as a user database. When storing the initial representation information of the resource node in the resource database, the server stores the initial representation information of the resource node and a media resource corresponding to the resource node in a binding manner, for example, stores the initial representation information of the resource node and a name or link of the media resource corresponding to the resource node in a binding manner. When storing the target representation information of the first-class object node in the object database, the server stores the target representation information of the first-class object node and a first-class object corresponding to the first-class object node in a binding manner, for example, stores the target representation information of the object node and an object identifier of the object corresponding to the object node in a binding manner, where the object identifier is an object account. When storing the target representation information of the second-class object node in the object database, the server stores the target representation information of the second-class object node and a second-class object corresponding to the second-class object node in a binding manner, for example, stores the target representation information of the object node and an object identifier of the object corresponding to the object node in a binding manner, where the object identifier is an object account. In some embodiments, types of the resource database and the object database are both a remote dictionary server (Redis).

306. The server recommends media resources to the first-class object based on the target representation information of the first-class object node.

In a possible implementation, the server determines, based on the target representation information of the first-class object node, at least one candidate object whose similarity to the first-class object meets a first similarity condition. The server recommends, to the first-class object, a media resource on which the at least one candidate object has had the target interaction behavior.

That the similarity between the candidate object and the first-class object meets the first similarity condition means that similarity between representation information of the candidate object and the target representation information of the first-class object is greater than or equal to a first similarity threshold. The first similarity threshold is set by a technician according to an actual situation, which is not limited in the embodiments of this application. This manner is also a manner of UCF recall.

In this implementation, the server can determine the candidate object based on the target representation information of the first-class object node and recommend, to the first-class object, the media resource on which the candidate object has had the target interaction behavior. Since the candidate object is an object whose similarity to the first-class object is high, the media resource on which the candidate object has had the target interaction behavior may be the media resource preferred by the first-class object. The accuracy of media resource recommendation in this manner is high.

For example, in response to a resource recommendation request, the server performs a query in the object database based on an identifier of the first-class object carried by the resource recommendation request, to obtain the target representation information of the first-class object. The server performs matching in the object database based on the target representation information of the first-class object, to obtain at least one candidate object whose similarity between representation information and the target representation information is greater than or equal to the first similarity threshold. The server recommends, to the first-class object, a media resource on which the at least one candidate object has had the target interaction behavior, that is, recommends, to the first-class object, a media resource viewed, liked, shared, commented, and favorited by the at least one candidate object.

In some embodiments, the similarity is cosine similarity, an inner product, or Hamming distance, which is not limited in the embodiments of this application. The server determines the similarity by using two vector search engines: Approximate Nearest Neighbors Oh Yeah (Annoy) and Facebook AI Similarity Search (Faiss).

In some embodiments, another method for recommending media resources to the first-class object is further provided. The server obtains a resource recommendation request. The resource recommendation request carries an identifier of a media resource that is being viewed by the first-class object. The server performs a query in the resource database based on the identifier of the media resource to obtain initial representation information of the media resource. The server performs matching in the resource database based on the initial representation information of the media resource to obtain at least one candidate media resource. The at least one candidate media resource is a media resource whose similarity to the media resource meets a second similarity condition. The server recommends the at least one candidate media resource to the first-class object.

That the similarity between the candidate media resource and the media resource meets the second similarity condition means that similarity between initial representation information of the candidate media resource and the initial representation information corresponding to the media resource is greater than or equal to a second similarity threshold. The second similarity threshold is set by a technician according to an actual situation, which is not limited in the embodiments of this application. This manner is also a manner of ICF recall.

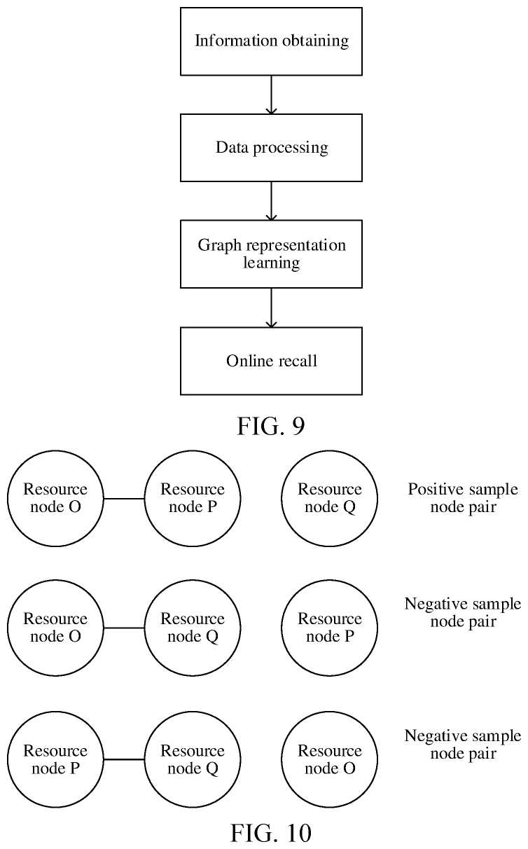

The following describes the technical solutions provided in the embodiments of this application with reference to FIG. 9 and steps 301-305. Referring to FIG. 9, the method includes information obtaining, that is, step 301; data processing, that is, step 302; graph representation learning, that is, steps 303 and 304; and online recall, that is, steps 305 and 306.

After steps 301-306 are described, the following describes a method for training the graph neural network in an embodiment of this application.

In a possible implementation, the server obtains a plurality of positive sample node pairs and a plurality of negative sample node pairs based on the connecting line between the plurality of nodes, that is, the edge connecting different nodes in the heterogeneous graph. The positive sample node pair is two nodes of the same type indirectly connected in the heterogeneous graph, and the negative sample node pair is two nodes of the same type not connected in the heterogeneous graph. The server trains the graph neural network based on first difference information of initial representation information of each of the positive sample node pairs and second difference information of initial representation information of each of the negative sample node pairs.

The indirect connection means that two nodes of the same type are directly connected to a node of a different type. The direct connection means that there is a connecting line between nodes. For example, if two first-class object nodes are directly connected to a resource node, the two first-class object nodes are indirectly connected to each other, and the two first-class object nodes form a positive sample node pair. The purpose of training the graph neural network based on the first difference information and the second difference information is to make the first difference information as small as possible and to make the second difference information as large as possible. This training manner is also referred to as representation learning.

In some embodiments, the server can directly generate the negative sample node pair based on the obtained positive sample node pair. That is, the server replaces a resource node in the obtained positive sample node pair with any resource node in the heterogeneous graph, or replaces an object node in the obtained positive sample node pair with any object node in the heterogeneous graph. Referring to FIG. 10, there are three resource nodes, a resource node O and a resource node P form a positive sample node pair, and neither the resource node O nor the resource node P forms a positive sample node pair with a resource node Q. In this case, the resource node O or the resource node P in the positive sample node pair including the resource node O and the resource node P is directly replaced with the resource node Q, to obtain a negative sample node pair.

In a possible implementation, in addition to training the graph neural network by the representation learning, an embodiment of this application further provides another manner for training the graph neural network: The server trains the graph neural network for any node in the plurality of nodes based on third difference information between any two of a plurality of pieces of candidate representation information of the node. The candidate representation information of the node is representation information obtained by performing graph convolution based on a group of meta-paths of the node.

The node is a resource node, a first-class object node, or a second-class object node. The following is described by using an example in which the node is a first-class object node. Because the plurality of pieces of candidate representation information of the node are obtained by performing graph convolution through the graph neural network based on a plurality of groups of meta-paths of the node, the plurality of pieces of candidate representation information of the node are all for representing an entity indicated by the node, and each group of meta-paths includes a plurality of meta-paths of the node. In this case, the purpose of training the graph neural network based on the third difference information is to make the third difference information as small as possible, that is, to make the plurality of pieces of candidate representation information obtained by performing graph convolution based on the plurality of groups of meta-paths as similar as possible. In some embodiments, this training manner is also referred to as contrastive learning.

In this implementation, the ideas of contrastive learning and transfer learning can increase the accuracy of the target representation information, thereby increasing the accuracy of media resource recommendation based on the target representation information.

The server can train the graph neural network in any one of the foregoing manners or train the graph neural network in both the two manners, which is not limited in the embodiments of this application. When the graph neural network is trained in both the two manners, loss functions of the two manners are combined to obtain a combined loss function, and the graph neural network is trained by using a gradient descent method based on the combined loss function.

In some embodiments, after the graph neural network is trained, performance of the graph neural network can be further checked by offline evaluation. For initial representation information of a media resource, the server randomly obtains two media resources with similarity of initial representation information greater than or equal to a second similarity threshold, and a technician determines the relevance between the two media resources. For a first-class object or a second-class object, using a first-class object as an example, the server randomly obtains two first-class objects with similarity of target representation information greater than or equal to a first similarity threshold, and a technician determines the relevance between the two first-class objects.

The heterogeneous graph of the target resource service is obtained through the technical solution provided in this embodiment of this application. The heterogeneous graph includes nodes corresponding to a plurality of types of entities in the target resource service. The heterogeneous graph is processed through the graph neural network based on the plurality of types of meta-paths, to obtain the initial representation information of the first-class object node and the initial representation information of the second-class object node. Since the meta-paths connect different types of nodes, the initial representation information of the object nodes carries information about the media resources. The initial representation information of the first-class object node and the initial representation information of the second-class object node are fused based on the connecting line, to obtain the target representation information, which can more adequately represent the first-class object. The accuracy of recommending the media resource to the first-class object based on the target representation information is high.

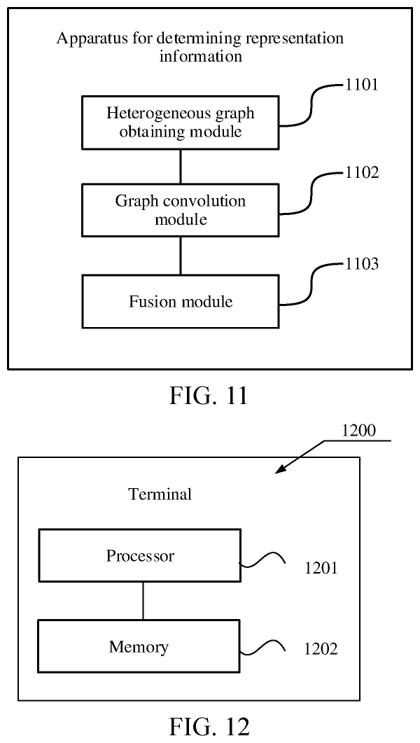

FIG. 11 is a schematic diagram of a structure of an apparatus for determining representation information according to an embodiment of this application. Referring to FIG. 11, the apparatus includes: a heterogeneous graph obtaining module 1101, a graph convolution module 1102, and a fusion module 1103.

The heterogeneous graph obtaining module 1101 is configured to obtain a heterogeneous graph of a target resource service, the heterogeneous graph including a plurality of types of nodes, each type of nodes including at least one node, each type of nodes being for representing one type of entities in the target resource service, an edge connecting different nodes being for representing an association relationship between entities, entities in the target resource service including a media resource, a first-class object, and a second-class object, the first-class object being an object whose quantity of times of a target interaction behavior with the media resource is less than a target quantity of times, and the second-class object being an object whose quantity of times of the target interaction behavior with the media resource is greater than or equal to the target quantity of times.

The graph convolution module 1102 is configured to perform graph convolution on the heterogeneous graph through a graph neural network based on a plurality of types of meta-paths of a plurality of nodes in the heterogeneous graph, to obtain initial representation information of a first-class object node and initial representation information of a second-class object node in the plurality of nodes, the first-class object node indicating the first-class object, the second-class object node indicating the second-class object, and any one of the plurality of types of meta-paths being for representing one connection manner between different types of nodes in the heterogeneous graph.

The fusion module 1103 is configured to fuse the initial representation information of the first-class object node and the initial representation information of the second-class object node based on the edge connecting different nodes in the heterogeneous graph, to obtain target representation information of the first-class object node, the target representation information being for recommending media resources to the first-class object.

In some embodiments, the heterogeneous graph obtaining module 1101 is configured to obtain an entity feature of each entity and association data between different types of entities in the target resource service, the association data being for representing an association relationship between the different types of entities; and generate the heterogeneous graph based on the entity feature of each entity and the association data between the different types of entities.

In some embodiments, the heterogeneous graph obtaining module 1101 is configured to generate a node for indicating each entity, a node feature of the node being the entity feature of the indicated entity, and different types of nodes being for indicating different types of entities; and add edges between the different types of generated nodes based on the association data between the different types of entities, to obtain the heterogeneous graph.

In some embodiments, the heterogeneous graph obtaining module 1101 is configured to perform at least one of the following steps: adding, when the association data represents that any first-class object has had the target interaction behavior on any media resource within a target time period, a first-class edge between a first-class object node indicating the first-class object and a resource node indicating the media resource, a weight of the first-class edge being positively correlated with a quantity of the target interaction behavior; adding, when the association data represents that any second-class object has had the target interaction behavior on any media resource within the target time period, the first-class edge between a second-class object node indicating the second-class object and a resource node indicating the media resource; adding, when the association data represents that a producer of any media resource is any first-class object, a second-class edge between a first-class object node indicating the first-class object and a resource node indicating the media resource; and adding, when the association data represents that a producer of any media resource is any second-class object, the second-class edge between a second-class object node indicating the second-class object and a resource node indicating the media resource.

In some embodiments, the graph convolution module 1102 is configured to perform, for any first-class object node, graph convolution on the first-class object node through the graph neural network based on a plurality of meta-paths of the first-class object node, to obtain the initial representation information of the first-class object node, all end points of the plurality of meta-paths of the first-class object node being the first-class object node; and perform, for any second-class object node, graph convolution on the second-class object node through the graph neural network based on a plurality of meta-paths of the second-class object node, to obtain the initial representation information of the second-class object node, all end points of the plurality of meta-paths of the second-class object node being the second-class object node.

In some embodiments, the graph convolution module 1102 is configured to fuse, through the graph neural network, node features of nodes through which the plurality of meta-paths of the first-class object node pass and a node feature of the first-class object node, to obtain the initial representation information of the first-class object node.

In some embodiments, the graph convolution module 1102 is configured to fuse, through the graph neural network, node features of nodes through which the plurality of meta-paths of the second-class object node pass and a node feature of the second-class object node, to obtain the initial representation information of the second-class object node.

In some embodiments, the fusion module 1103 is configured to determine, for any first-class object node, at least one relevant second-class object node and at least one irrelevant second-class object node of the first-class object node based on an edge between the first-class object node and a resource node, a second-class object indicated by the relevant second-class object node and the first-class object having had the target interaction behavior on a same media resource, and media resources on which a second-class object indicated by the irrelevant second-class object node has had the target interaction behavior being all different from media resources on which the first-class object has had the target interaction behavior; fuse the initial representation information of the first-class object node, initial representation information of the at least one relevant second-class object node, and initial representation information of the at least one irrelevant second-class object node, to obtain fused representation information of the first-class object node; and adjust the fused representation information of the first-class object node based on the initial representation information of the at least one relevant second-class object node, to obtain the target representation information of the first-class object node.

In some embodiments, the fusion module 1103 is configured to add a mask in the initial representation information of the first-class object node to obtain reference representation information of the first-class object node; and perform weighted summation on the reference representation information of the first-class object node, the initial representation information of the at least one relevant second-class object node, and the initial representation information of the at least one irrelevant second-class object node, to obtain the fused representation information of the first-class object node.

In some embodiments, the fusion module 1103 is configured to input the initial representation information of the at least one relevant second-class object node to a target classifier, and output, by the target classifier, an object type of the second-class object indicated by the relevant second-class object node; input the fused representation information of the first-class object node to the target classifier, and output, by the target classifier, an object type of the first-class object indicated by the first-class object node; and adjust the fused representation information of the first-class object node based on difference information between the object type of the second-class object and the object type of the first-class object, to obtain the target representation information of the first-class object node.

In some embodiments, the apparatus further includes: a training module, configured to obtain a plurality of positive sample node pairs and a plurality of negative sample node pairs based on the edge connecting different nodes in the heterogeneous graph, the positive sample node pair being two nodes of a same type indirectly connected in the heterogeneous graph, and the negative sample node pair being two nodes of a same type not connected in the heterogeneous graph; and train the graph neural network based on first difference information of initial representation information of each of the positive sample node pairs and second difference information of initial representation information of each of the negative sample node pairs.

In some embodiments, the apparatus further includes: a training module, configured to train the graph neural network for any node based on third difference information between any two of a plurality of pieces of candidate representation information of the node, the candidate representation information of the node being representation information obtained by performing graph convolution based on a group of meta-paths of the node.

In some embodiments, the apparatus further includes: a recommendation module, configured to determine, based on the target representation information of the first-class object node, at least one candidate object whose similarity to the first-class object meets a first similarity condition; and recommend, to the first-class object, a media resource on which the at least one candidate object has had the target interaction behavior.

When the apparatus for determining representation information provided in the foregoing embodiment determines the representation information, the division of the foregoing functional modules is merely used as an example for description. In practice, the foregoing functions are assigned to and completed by different functional modules as required. That is, an internal structure of a computer device is divided into different functional modules to complete all or some of the functions described above. In addition, the apparatus for determining representation information provided in the foregoing embodiment and the embodiments of the method for determining representation information belong to the same concept. For a specific implementation process, refer to the method embodiments. Details are not described herein again.

The heterogeneous graph of the target resource service is obtained through the technical solution provided in this embodiment of this application. The heterogeneous graph includes nodes corresponding to a plurality of types of entities in the target resource service. The heterogeneous graph is processed through the graph neural network based on the plurality of types of meta-paths, to obtain the initial representation information of the first-class object node and the initial representation information of the second-class object node. Since the meta-paths connect different types of nodes, the initial representation information of the object nodes carries information about the media resources. The initial representation information of the first-class object node and the initial representation information of the second-class object node are fused based on the connecting line, to obtain the target representation information, which can more adequately represent the first-class object. The accuracy of recommending the media resource to the first-class object based on the target representation information is high.

An embodiment of this application provides a computer device configured to perform the foregoing method. The computer device is implemented as a terminal or a server. The following first describes a structure of a terminal. FIG. 12 is a schematic diagram of a structure of a terminal according to an embodiment of this application. The terminal 1200 includes: one or more processors 1201 and one or more memories 1202.

The processor 1201 includes one or more processing cores, for example, a 4-core processor or an 8-core processor. The processor 1201 may be implemented in at least one hardware form of digital signal processing (DSP), a field-programmable gate array (FPGA), and a programmable logic array (PLA). The processor 1201 also includes a main processor and a coprocessor. The main processor is a processor configured to process data in an awake state, and is also referred to as a central processing unit (CPU). The coprocessor is a low-power-consumption processor configured to process data in a standby state. In some embodiments, the processor 1201 is integrated with a graphics processing unit (GPU). The GPU is configured to render and draw content that needs to be displayed on a display screen. In some embodiments, the processor 1201 further includes an artificial intelligence (AI) processor. The AI processor is configured to process computing operations related to machine learning.

The memory 1202 includes one or more computer-readable storage media. The computer-readable storage medium is non-transitory. The memory 1202 further includes a high-speed random access memory and a non-volatile memory, for example, one or more disk storage devices or flash storage devices. In some embodiments, the non-transitory computer-readable storage medium in the memory 1202 is configured to store at least one computer program, and the at least one computer program is executed by the processor 1201 to implement the method for determining representation information provided in the method embodiments of this application.

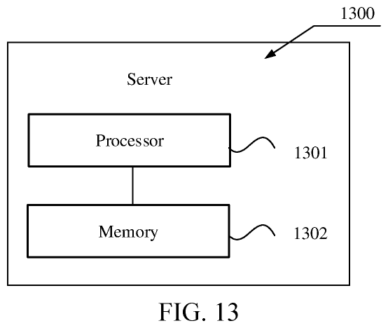

In some embodiments, the computer device is provided as a server. FIG. 13 is a schematic diagram of a structure of a server according to an embodiment of this application. The server 1300 may vary a lot due to different configurations or performance, and may include one or more processors (central processing units, CPUs) 1301 and one or more memories 1302. The one or more memories 1302 store at least one computer program, and the at least one computer program is loaded and executed by the one or more processors 1301 to implement the method provided in the foregoing method embodiments.

In an exemplary embodiment, a non-transitory computer-readable storage medium is further provided. The computer-readable storage medium stores at least one computer program. The at least one computer program is loaded and executed by a processor to implement the method for determining representation information. For example, the computer-readable storage medium is a read-only memory (ROM), a random access memory (RAM), a compact disc ROM (CD-ROM), a magnetic tape, a floppy disk, an optical data storage device, or the like.

In an exemplary embodiment, a computer program product is further provided. The computer program product is executed by a processor to implement the method for determining representation information.

In some embodiments, the computer program involved in the embodiments of this application may be deployed on a computer device for execution, or deployed on a plurality of computer devices located at a location for execution, or deployed on a plurality of computer devices distributed at a plurality of locations and interconnected through a communication network for execution, or deployed on a block chain system formed by a plurality of computer devices distributed at a plurality of locations and interconnected through a communication network for execution.

A person of ordinary skill in the art may understand that all or some of the steps of the foregoing embodiments are implemented by hardware or a program instructing related hardware. The program is stored in a computer-readable storage medium. The storage medium is a read-only memory, a magnetic disk, or an optical disc.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules or units. Moreover, each module can be part of an overall module that includes the functionalities of the module. The foregoing descriptions are merely optional embodiments of this application, but are not intended to limit this application. Any modification, equivalent replacement, or improvement made within the spirit and principle of this application shall fall within the protection scope of this application.

What is claimed is:

1. A method for determining representation information performed by a computer device, the method comprising:
obtaining a heterogeneous graph of a target resource service, the heterogeneous graph comprising a plurality of types of nodes, each type of nodes comprising at least one node representing one type of entities in the target resource service, an edge connecting different nodes being for representing an association relationship between entities, entities in the target resource service comprising a media resource, a first-class object, and a second-class object;
performing graph convolution on the heterogeneous graph through a graph neural network based on a plurality of types of meta-paths of a plurality of nodes in the heterogeneous graph, to obtain initial representation information of a first-class object node corresponding to the first-class object and initial representation information of a second-class object node corresponding to the second-class object; and
fusing the initial representation information of the first-class object node and the initial representation information of the second-class object node based on the edge connecting different nodes in the heterogeneous graph, to obtain target representation information of the first-class object node for recommending media resources to the first-class object.

2. The method according to claim 1, wherein the obtaining a heterogeneous graph of a target resource service comprises:
obtaining an entity feature of each entity and association data between different types of entities in the target resource service, the association data being for representing an association relationship between the different types of entities; and
generating the heterogeneous graph based on the entity feature of each entity and the association data between the different types of entities.

3. The method according to claim 1, wherein the first-class object is an object whose quantity of times of a target interaction behavior with the media resource is less than a target quantity of times, and the second-class object is an object whose quantity of times of the target interaction behavior with the media resource is greater than or equal to the target quantity of times.

4. The method according to claim 1, wherein the performing graph convolution on the heterogeneous graph through a graph neural network based on a plurality of types of meta-paths of a plurality of nodes in the heterogeneous graph, to obtain initial representation information of a first-class object node corresponding to the first-class object and initial representation information of a second-class object node corresponding to the second-class object comprises:
performing, for any first-class object node, graph convolution on the first-class object node based on a plurality of meta-paths of the first-class object node, to obtain the initial representation information of the first-class object node, all end points of the plurality of meta-paths of the first-class object node being the first-class object node; and
performing, for any second-class object node, graph convolution on the second-class object node based on a plurality of meta-paths of the second-class object node, to obtain the initial representation information of the second-class object node, all end points of the plurality of meta-paths of the second-class object node being the second-class object node.

5. The method according to claim 1, further comprising:
obtaining a plurality of positive sample node pairs and a plurality of negative sample node pairs based on the edge connecting different nodes in the heterogeneous graph, the positive sample node pair being two nodes of a same type indirectly connected in the heterogeneous graph, and the negative sample node pair being two nodes of a same type not connected in the heterogeneous graph; and
training the graph neural network based on first difference information of initial representation information of each of the positive sample node pairs and second difference information of initial representation information of each of the negative sample node pairs.

6. The method according to claim 1, further comprising:
training the graph neural network for any node based on third difference information between any two of a plurality of pieces of candidate representation information of the node, the candidate representation information of the node being representation information obtained by performing graph convolution based on a group of meta-paths of the node.

7. The method according to claim 1, further comprising:
determining, based on the target representation information of the first-class object node, at least one candidate object whose similarity to the first-class object meets a first similarity condition; and recommending, to the first-class object, a media resource on which the candidate object has had the target interaction behavior.

8. A computer device, comprising one or more processors and one or more memories, the one or more memories storing at least one computer program, and the at least one computer program being loaded and executed by the one or more processors and causing the computer device to implement a method for determining representation information including:
obtaining a heterogeneous graph of a target resource service, the heterogeneous graph comprising a plurality of types of nodes, each type of nodes comprising at least one node representing one type of entities in the target resource service, an edge connecting different nodes being for representing an association relationship between entities, entities in the target resource service comprising a media resource, a first-class object, and a second-class object;
performing graph convolution on the heterogeneous graph through a graph neural network based on a plurality of types of meta-paths of a plurality of nodes in the heterogeneous graph, to obtain initial representation information of a first-class object node corresponding to the first-class object and initial representation information of a second-class object node corresponding to the second-class object; and
fusing the initial representation information of the first-class object node and the initial representation information of the second-class object node based on the edge connecting different nodes in the heterogeneous graph, to obtain target representation information of the first-class object node for recommending media resources to the first-class object.

9. The computer device according to claim 8, wherein the obtaining a heterogeneous graph of a target resource service comprises:
obtaining an entity feature of each entity and association data between different types of entities in the target resource service, the association data being for representing an association relationship between the different types of entities; and
generating the heterogeneous graph based on the entity feature of each entity and the association data between the different types of entities.

10. The computer device according to claim 8, wherein the first-class object is an object whose quantity of times of a target interaction behavior with the media resource is less than a target quantity of times, and the second-class object is an object whose quantity of times of the target interaction behavior with the media resource is greater than or equal to the target quantity of times.

11. The computer device according to claim 8, wherein the performing graph convolution on the heterogeneous graph through a graph neural network based on a plurality of types of meta-paths of a plurality of nodes in the heterogeneous graph, to obtain initial representation information of a first-class object node corresponding to the first-class object and initial representation information of a second-class object node corresponding to the second-class object comprises:
performing, for any first-class object node, graph convolution on the first-class object node based on a plurality of meta-paths of the first-class object node, to obtain the initial representation information of the first-class object node, all end points of the plurality of meta-paths of the first-class object node being the first-class object node; and
performing, for any second-class object node, graph convolution on the second-class object node based on a plurality of meta-paths of the second-class object node, to obtain the initial representation information of the second-class object node, all end points of the plurality of meta-paths of the second-class object node being the second-class object node.

12. The computer device according to claim 8, wherein the method further comprises:
obtaining a plurality of positive sample node pairs and a plurality of negative sample node pairs based on the edge connecting different nodes in the heterogeneous graph, the positive sample node pair being two nodes of a same type indirectly connected in the heterogeneous graph, and the negative sample node pair being two nodes of a same type not connected in the heterogeneous graph; and
training the graph neural network based on first difference information of initial representation information of each of the positive sample node pairs and second difference information of initial representation information of each of the negative sample node pairs.

13. The computer device according to claim 8, wherein the method further comprises:
training the graph neural network for any node based on third difference information between any two of a plurality of pieces of candidate representation information of the node, the candidate representation information of the node being representation information obtained by performing graph convolution based on a group of meta-paths of the node.

14. The computer device according to claim 8, wherein the method further comprises:
determining, based on the target representation information of the first-class object node, at least one candidate object whose similarity to the first-class object meets a first similarity condition; and recommending, to the first-class object, a media resource on which the candidate object has had the target interaction behavior.

15. A non-transitory computer-readable storage medium, storing at least one computer program, the at least one computer program being loaded and executed by a processor of a computer device and causing the computer device to implement a method for determining representation information including:
obtaining a heterogeneous graph of a target resource service, the heterogeneous graph comprising a plurality of types of nodes, each type of nodes comprising at least one node representing one type of entities in the target resource service, an edge connecting different nodes being for representing an association relationship between entities, entities in the target resource service comprising a media resource, a first-class object, and a second-class object;
performing graph convolution on the heterogeneous graph through a graph neural network based on a plurality of types of meta-paths of a plurality of nodes in the heterogeneous graph, to obtain initial representation information of a first-class object node corresponding to the first-class object and initial representation information of a second-class object node corresponding to the second-class object; and
fusing the initial representation information of the first-class object node and the initial representation information of the second-class object node based on the edge connecting different nodes in the heterogeneous graph, to obtain target representation information of the first-class object node for recommending media resources to the first-class object.

16. The non-transitory computer-readable storage medium according to claim 15, wherein the obtaining a heterogeneous graph of a target resource service comprises:
obtaining an entity feature of each entity and association data between different types of entities in the target resource service, the association data being for representing an association relationship between the different types of entities; and
generating the heterogeneous graph based on the entity feature of each entity and the association data between the different types of entities.

17. The non-transitory computer-readable storage medium according to claim 15, wherein the first-class object is an object whose quantity of times of a target interaction behavior with the media resource is less than a target quantity of times, and the second-class object is an object whose quantity of times of the target interaction behavior with the media resource is greater than or equal to the target quantity of times.

18. The non-transitory computer-readable storage medium according to claim 15, wherein the method further comprises:
obtaining a plurality of positive sample node pairs and a plurality of negative sample node pairs based on the edge connecting different nodes in the heterogeneous graph, the positive sample node pair being two nodes of a same type indirectly connected in the heterogeneous graph, and the negative sample node pair being two nodes of a same type not connected in the heterogeneous graph; and
training the graph neural network based on first difference information of initial representation information of each of the positive sample node pairs and second difference information of initial representation information of each of the negative sample node pairs.

19. The non-transitory computer-readable storage medium according to claim 15, wherein the method further comprises:
training the graph neural network for any node based on third difference information between any two of a plurality of pieces of candidate representation information of the node, the candidate representation information of the node being representation information obtained by performing graph convolution based on a group of meta-paths of the node.

20. The non-transitory computer-readable storage medium according to claim 15, wherein the method further comprises:
determining, based on the target representation information of the first-class object node, at least one candidate object whose similarity to the first-class object meets a first similarity condition; and recommending, to the first-class object, a media resource on which the candidate object has had the target interaction behavior.
